(19) United States
(12) Patent Application Publication
(10) Pub. No.: US 2025/0371573 A1
(43) Pub. Date: Dec. 4, 2025

(54) INDIRECT INFLUENCE BOOST TRACKING AND ATTRIBUTION ALLOCATION

(71) Applicant: Live Nation Entertainment, Inc., Beverly Hills, CA (US)

(72) Inventor: Samantha Sichel, Los Angeles, CA (US)

(73) Assignee: Live Nation Entertainment, Inc., Beverly Hills, CA (US)

(21) Appl. No.: 19/224,150

(22) Filed: May 30, 2025

Related U.S. Application Data
(60) Provisional application No. 63/653,692, filed on May 30, 2024.

(51) Int. Cl. G06Q 30/0242; G06Q 20/38; G06Q 50/00

(52) U.S. Cl. CPC G06Q 30/0246; G06Q 20/385; G06Q 50/01

(57) ABSTRACT

An attribution management system for rewarding view-based attribution on an online platform includes an attribution server that retrieves from a business manager over a data communication network using an Application Programming Interface (API), a set of candidate posts. Pixel traffic from the set of candidate posts is tracked based on first party data and social media posts. User interaction, including clicks and views, is identified on the set of candidate posts. Candidate posts below a pre-determined threshold value are boosted using a predetermined number of user interactions. A source of the one or more boosted candidate posts is identified using tags. At least one purchase from the views on one or more boosted candidate posts is identified. An attribution amount for each owner of the one or more boosted candidate posts is determined based on the at least one purchase using the source identified by the tags.

### PRIORITY

This application claims the benefit of and priority to U.S. Provisional Patent Application No. 63/653,692, filed May 30, 2024, which is hereby incorporated by reference in its entirety.

### BACKGROUND

This disclosure relates in general to tracking and allocating attribution to influencers for influencing users via an online post, among other things.

Currently, influencers on the social media platform are being rewarded for their sales performance. Influencer-based affiliate marketing landscape only commissions influencers based on click-based attribution. However, the influencers indirectly drive the users towards purchase of the products or services. A user may not necessarily purchase the products or services at the instant of time the user views the posts or advertisements but may purchase it after a few days. Traditionally, focus is given more on actual sales of the products or services by the influencers. Indirect or view-based influence on purchase decisions of the users is ignored.

The indirect influence created through the views increases the sales and deserves recognition. Awareness and impact that the influencers create on the users through their posts should be credited. Accordingly, rewards and commissions should be provided to the influencers based on the role they play in driving the purchase decisions of the users.

Furthermore, some posts are boosted to increase the reach of the posts to a larger audience. Identifying a correlation between views, clicks, and/or purchases, with the boosted posts is difficult and complex. Moreover, view-based attribution of the influencers in the sales and promotion is recognizable and attributable.

### SUMMARY

In one embodiment, the present disclosure provides one or more techniques that aims to eliminate the drawbacks of the traditional influencer rewarding programmes and attribution management system by rewarding the creators for the views that convert into purchases and likely influence the sales.

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

Certain aspects and features of the present disclosure relate to an attribution management system for rewarding view-based attribution on an online platform includes an attribution server that retrieves from a business manager over a data communication network using an Application Programming Interface (API), a set of candidate posts. Pixel traffic from the set of candidate posts is tracked based on first party data and social media posts. User interaction including clicks and views are identified on the set of candidate posts. Candidate posts below a pre-determined threshold value are boosted using a predetermined number of user interactions. A source of the one or more boosted candidate posts is identified using tags. At least one purchase from the views on one or more boosted candidate posts is identified. An attribution amount for each owner of the one or more boosted candidate posts is determined based on the at least one purchase using the source identified by the tags. Other embodiments of this aspect include corresponding computer systems, apparatus, and computer programs recorded on one or more computer storage devices, each configured to perform the actions of the methods.

Certain embodiments of the present disclosure described herein relate to systems and methods that enhance and efficiently implement an attribution management system for providing view-based attribution to the influencers. One embodiment of the present disclosure relates to a method for boosting pixel traffic of candidate posts and generating a commission for purchases initiated on boosting the pixel traffic. In one step, a set of candidate posts are retrieved from a business manager using an Application Programming Interface (API) over a data communication network by an attribution server. The pixel traffic from the set of candidate posts is tracked based on first party data and social media posts using the business manager. The pixel traffic includes several user interactions, the user interactions include clicks, and views on the set of candidate posts. The first party data includes user data from user applications associated with the set of candidate posts. Candidate posts are identified from the set of candidate posts that has the number of user interactions below a pre-defined threshold value. A boost signal is applied to the candidate posts based on a predetermined number of user interactions to generate boosted candidate posts. The pixel traffic is tracked from the boosted candidate posts using an analytics engine to identify a source of the boosted candidate posts. The analytics engine uses tags to identify the source of the boosted candidate posts. At least one purchase is identified by a set of users initiated using the boosted candidate posts. An attribution amount for each owner of the boosted candidate posts is identified using the source identified by the tag by the attribution server based on the at least one purchase. Other embodiments of this aspect include corresponding computer systems, apparatus, and computer programs recorded on one or more computer storage devices, each configured to perform the actions of the methods.

Moreover, one general aspect includes the user-related data is acquired from the pixel traffic using the API based on a user device identifier and user account information associated with users identified from the source of the pixel traffic. At least one purchase by a plurality of users initiated using the set of candidate posts is identified. A user attribution amount is allocated by the attribution server to each owner of the set of candidate posts for the at least one purchase initiated from the set of candidate posts. The at least one purchase by the set of users initiated using the one or more boosted candidate posts is correlated with the user interactions on the one or more boosted candidate posts. The attribution amount is allocated by the attribution server to each owner of the one or more boosted candidate posts for the at least one purchase initiated from the one or more boosted candidate posts.

In one exemplary embodiment, a system of one or more computers is configured to execute specific operations through software, firmware, or hardware. This includes differentiating, by the attribution server, source links of the at least one purchase by the set of users initiated using the one or more boosted candidate posts based on the user data; calculating, by the attribution server, a first attribution amount for each owner of the one or more boosted candidate posts based on the source links; calculating, by the attribution server, a second attribution amount for each owner of the one or more boosted candidate posts based on the views on the one or more boosted candidate posts; and calculating, by the attribution server, a third attribution amount for each owner of the one or more boosted candidate posts based on the clicks on the one or more boosted candidate posts.

Further, in one exemplary embodiment, the first attribution amount is a function of a type of source link, and the type of source link is a payment link, a webpage, or a code used for the at least one purchase.

Beyond the method, the correlation of the at least one purchase by the set of users initiated using the one or more boosted candidate posts with the at least one purchase by a plurality of users initiated using the set of candidate posts is performed using a machine learning algorithm.

In one exemplary embodiment, the one or more candidate posts are identified from the set of candidate posts based on Engagement Rate (ER), reach, video views, shares exceeding respective thresholds and having trackable conversions over time.

Furthermore, the one or more candidate posts are identified from the set of candidate posts based on any one of shares, video views, Engagement Rate (ER) exceeding respective thresholds and having and trackable conversions over time. Other embodiments of this aspect include corresponding computer systems, apparatus, and computer programs recorded on one or more computer storage devices, each configured to perform the actions of the methods.

Certain aspects and features of the present disclosure relate to a system for boosting pixel traffic of candidate posts and generating a commission for purchases initiated on boosting the pixel traffic. The system comprises an attribute server that retrieves a set of candidate posts from a business manager using an Application Programming Interface (API) over a data communication network. The pixel traffic from the set of candidate posts is tracked based on first party data and social media posts using the business manager. The pixel traffic includes several user interactions. The user interactions include clicks, and views on the set of candidate posts. The first party data includes user data from user applications associated with the set of candidate posts. Candidate posts are identified from the set of candidate posts that has the number of user interactions below a pre-defined threshold value. A boost signal is applied to the candidate posts based on a predetermined number of user interactions to generate boosted candidate posts. The pixel traffic is tracked from the boosted candidate posts using an analytics engine to identify a source of the boosted candidate posts, and the analytics engine uses tags to identify the source of the boosted candidate posts. At least one purchase is identified by a set of users initiated using the boosted candidate posts. An attribution amount for each owner of the boosted candidate posts is identified using the source identified by the tag by the attribution server based on the at least one purchase. Other embodiments of this aspect include corresponding computer systems, apparatus, and computer programs recorded on one or more computer storage devices, each configured to perform the actions of the methods.

Certain aspects and features of the present disclosure relate to a non-transitory computer-readable medium containing instructions that cause the processor to perform a method for boosting pixel traffic of candidate posts and generating a commission for purchases initiated on boosting the pixel traffic when executed by a processor. A set of candidate posts is retrieved from a business manager using an Application Programming Interface (API) over a data communication network by an attribution server. The pixel traffic from the set of candidate posts is tracked based on first party data and social media posts using the business manager. The pixel traffic includes several user interactions, the user interactions include clicks, and views on the set of candidate posts. The first party data includes user data from user applications associated with the set of candidate posts. Candidate posts are identified from the set of candidate posts that has the number of user interactions below a pre-defined threshold value. A boost signal is applied to the candidate posts based on a predetermined number of user interactions to generate boosted candidate posts. The pixel traffic is tracked from the boosted candidate posts using an analytics engine to identify a source of the boosted candidate posts, and the analytics engine uses tags to identify the source of the boosted candidate posts. At least one purchase is identified by a set of users initiated using the boosted candidate posts. An attribution amount for each owner of the boosted candidate posts is identified using the source identified by the tag by the attribution server based on the at least one purchase. Other embodiments of this aspect include corresponding computer systems, apparatus, and computer programs recorded on one or more computer storage devices, each configured to perform the actions of the methods.

### BRIEF DESCRIPTION OF THE DRAWINGS

The present disclosure is described in conjunction with the appended figures:

FIG. 1 illustrates a block diagram of an attribution management system according to an embodiment of the present disclosure;

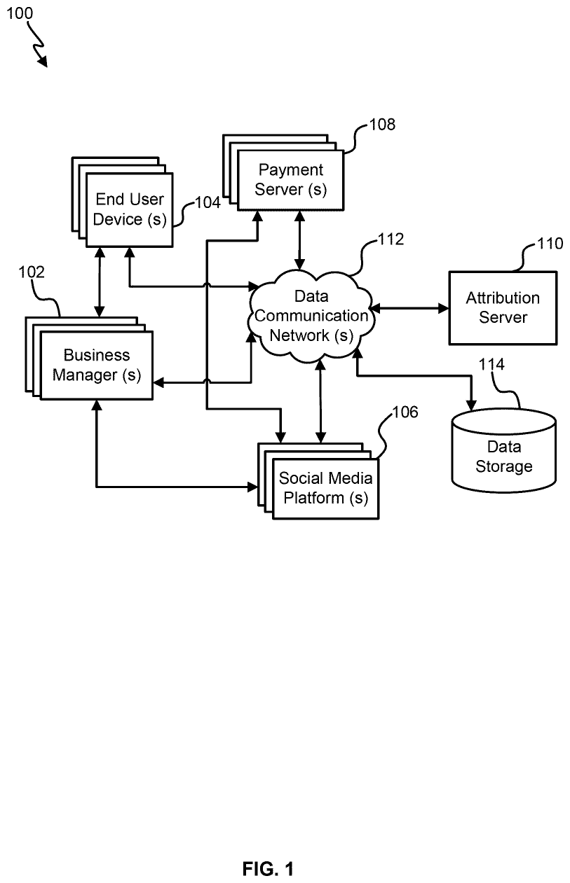

FIG. 2 illustrates a block diagram of a user device and application interface according to an embodiment of the present disclosure;

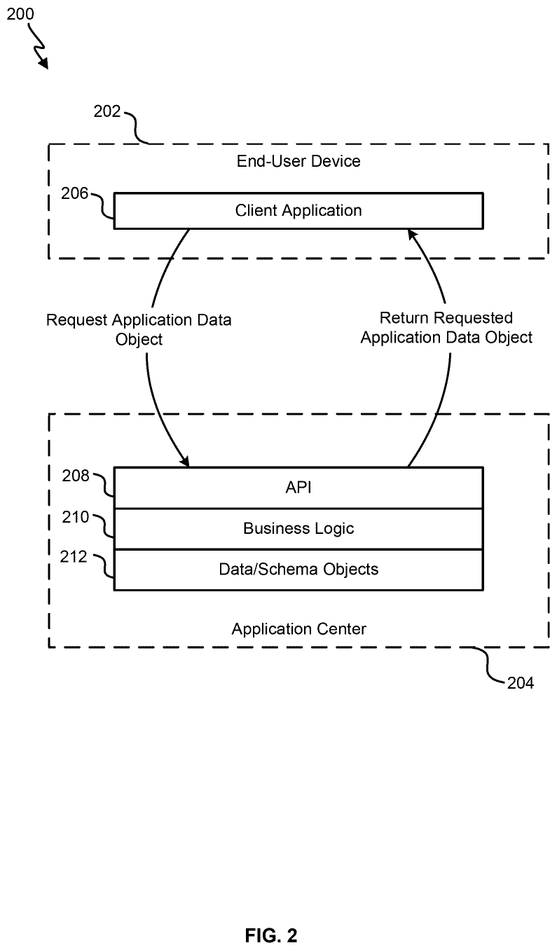

FIG. 3 illustrates a block diagram of an attribution server according to an embodiment of the present disclosure;

FIG. 4 illustrates a block diagram of an end-user device according to an embodiment of the present disclosure;

FIG. 5 illustrates a block diagram of a power booster according to an embodiment of the present disclosure;

FIG. 6 illustrates a flow diagram for an attribution management system for determining an attribution amount for creators of an online post according to an embodiment of the present disclosure;

FIG. 7 illustrates a mobile application running on an end-user device(s) for receiving details of the attribution in terms of commission in accordance with an embodiment of the present disclosure;

FIG. 8A illustrates a flowdiagram describing attribution management of organic posts according to another embodiment of the present disclosure;

FIG. 8B illustrates a flowdiagram describing attribution management of boosted posts according to another embodiment of the present disclosure;

FIG. 9 illustrates a a flowchart describing a process for rewarding view-based attribution on an online platform such as social media according to another embodiment of the present disclosure;

FIG. 10 illustrates a flowchart of a process for acquiring user data from business manager portals of social media platforms used for allocating attribution to users of social media candidate posts according to another embodiment of the present disclosure;

FIG. 11 illustrates a flowchart of a process for boosting pixel traffic associated with a set of candidate posts and generating a commission for purchases initiated after boosting the pixel traffic according to another embodiment of the present disclosure;

FIG. 12 illustrates a flowchart of a process for correlating user interactions on a number of candidate posts with sales/revenue generated from the candidate posts according to another embodiment of the present disclosure; and

FIG. 13 illustrates a flowchart of a block for determining and boosting a set of candidate posts according to another embodiment of the present disclosure.

In the appended figures, similar components and/or features may have the same reference label. Further, various components of the same type maybe distinguished by following the reference label with a second alphabetical label that distinguishes among the similar components. If only the first reference label is used in the specification, the description applies to any one of the similar components having the same first reference label irrespective of the second reference label.

### DETAILED DESCRIPTION

The ensuing description provides preferred exemplary embodiment(s) only and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

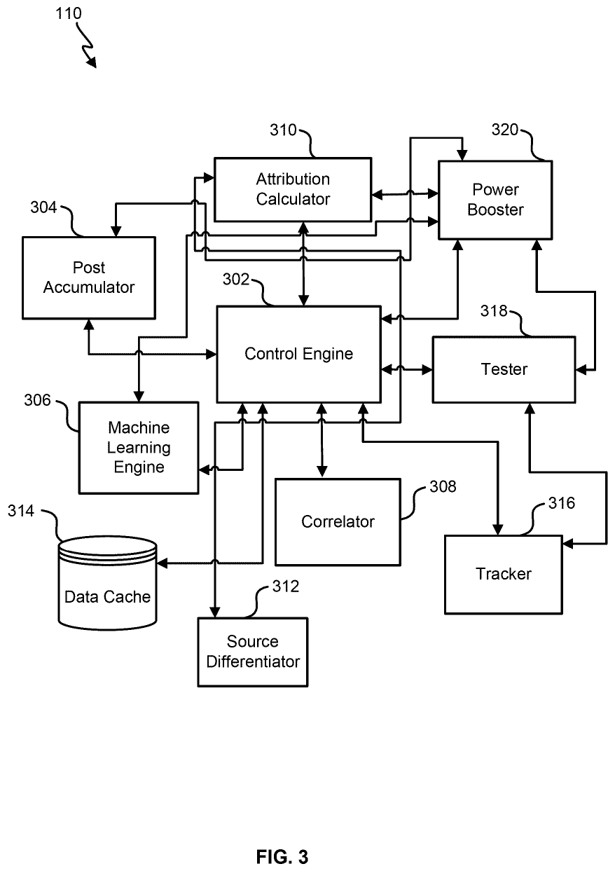

Referring to FIG. 3, illustrates a block diagram of an attribution management system 100, according to an embodiment of the present disclosure. The attribution management system 100 provides influence-based attribution to the creators or influencers of posts on an online platform, such as a social media platform. The attribution management system 100 includes business manager(s) 102, end-user device(s) 104, social media platform(s) 106, payment server(s) 108, an attribution server 110, a data communication network(s) 112, and a data storage 114. Different components of the attribution management system 100 are connected via the data communication network(s) 112. The data communication network(s) 112 can provide a wireless connection with other components.

In some configurations, a business manager(s) 102 communicates with the social media platform(s) 106 to acquire user data from the social media platform(s) 106 and first-party data related to the online posts by creators or influencers. The first-party data includes the user data from user applications (including web and mobile applications) associated with the set of candidate posts. The first-party data includes other sources of the user data like browser history, applications used, user account information on application, purchase history, etc. The business manager(s) 102 acquires the user data of users who clicks, views or purchases from the posts. The user data includes usernames, social media accounts of the users, user's email addresses, user's recent purchases from the posts, payment information for the purchases. The payment information is received via the payment server(s) 108. The payment information includes payment for a purchase made from the post. The business manager(s) 102 includes a number of servers managing the user data, social media assets, analysing the user data, and providing meaningful insights to the attribution server 110.

The business manager(s) 102 also collects data regarding pixel traffic from the posts and triggers the attribution server 110 when a spike is detected in the pixel traffic, that is, a number of clicks, views has increased for one or more posts. The attribution server 110 boosts the posts that indicate a scope for an increase in the clicks, views, and related purchases. The business manager(s) 102 acquires the analytics information on posts from the social media platform(s) 106 and the first-party data and provides the analytics to the attribution server 110. The first-party data includes user data from the mobile applications, the cloud applications, and the web applications. The business manager(s) 102 is a communication bridge between the social media platform(s) 106 and the attribution server 110. An Application Programming Interface (API) is used by the attribution server 110 to acquire the analytics information and the user data from the business manager(s) 102. In another embodiment, the API may directly establish communication between the social media platform(s) 106 and the attribution server 110.

The end-user device(s) 104 can be used to create and broadcast posts on the social networking platforms on the social media platform(s) 106. The end-user device(s) 104 can be any portable computing device, e.g., smartphones, mobile phones, tablets, and/or other similar devices. A plurality of activities can be performed with the help of the end-user device(s) 104, for example, but not limited to, likes, clicks, views, managing user accounts, and/or purchases of products or services using an application running on the end-user device(s) 104.

The user uses a mobile application installed on the end-user device(s) 104 to post an image, video, animation, Graphics Interchange Format (GIF), text, code, and/or a combination thereof on the social media platform(s) 106. The user is an influencer or a creator of the post and is the owner of the post on a social networking site. The user can act as a creator by posting advertisements (ads), videos, marketing products/services, or generating content through posts on the mobile application of the social networking site. The user can also act as a user of the posts by clicking, viewing, liking, commenting, and/or purchasing the products/services from the posts. When the user is the creator of the post, the social networking sites provide an attribution amount in terms of incentives or commission for the purchases made using the user's post.

The social media platform(s) 106 include a number of social networking (SN) platforms like Facebook™, LinkedIn™, Instagram™, YouTube™, TikTok™, etc. and the many different kinds of user-to-user associations which can be formed by activities carried out on these various platforms in addition to user activities carried out on the social media platforms. The social media platform(s) 106 manage the user accounts of the social networking platforms. Data regarding the creators of the posts and users of the post, including clicks, likes, views, and purchases, is provided by the social media platform(s) 106 to the business manager(s) 102 and/or the attribution server 110 via the API.

A payment server(s) 108 includes a gateway for the payment of the purchase of a product or a service mentioned in the post. The payment server(s) 108 receive the purchase amount from the user's bank account and confirm the payment. The payment server(s) 108 store payment related information of the user and provide it to the business manager(s) 102 for retrieval at the time of processing. The payment server(s) 108 include a number of payment options, such as online payment, digital wallet, payments using cards, bank accounts, etc.

The attribution server 110 calculates and assigns the attribution amount to the creators and influencers for the posts. The attribution server 110 receives the user interactions, including clicks and views for the post, from the business manager(s) 102 and/or the social media platform(s) 106 using the API. The attribution server 110 identifies purchases made using the clicks and the views of products or services marketed on the posts of the creators. The attribution server 110 determines an attribution amount for the purchased marketed products/services through the clicks (direct purchases) and the purchased marketed products/services through the views after some time or days (indirect), respectively. The attribution server 110 identifies direct (click-based) and indirect purchases (view-based) of related products/services that are not in the post other than the marketed product/services but indirectly linked to the post. For example, a post by a singer advertising a product X is viewed by a number of users. One or more users click and purchase the product X directly, while other users view and purchase the product X a few days later. Some users view a website for a concert where the singer is to perform and purchase the tickets from the company's website, while some users may purchase the tickets using the direct links from the posts. The purchase of the tickets is a related service as it is not directly linked to the post, but indirectly associated with the post.

The attribution server 110 identifies purchases of the marketed and related products/services from the direct links on the posts, copied links of the posts on browser of the end-user device(s) 104, mobile applications, third-party applications, company websites, influencer codes, etc. some users may copy the links of the post on the browsers as they find the direct links on the post being unsafe. Other users may purchase the same product/service on the post directly from the company website or its mobile application, but not by clicking on the post. For example, booking the ticket for a concert directly from the concert's website or mobile application, but not from the links in the post. Using influencers' code while checking out the purchase may provide a discount to the users. The use of the coupon or the influencer's code is also tracked to calculate the attribution amount.

The attribution server 110 determines whether one or more posts have to be boosted. A determination is based on boosting rules. The boosting rules are based on the Engagement Rate (ER), reach, video views, shares exceeding respective thresholds, and having trackable conversions over time. For example, according to a boosting rule that triggers a boost on posts only if all the conditions are met over time, including ER≥3%, reach≥seven thousand, video views≥five thousand, shares≥fifty, and trackable conversions. Similarly, another boosting rule triggers a boost on posts if any of the conditions are met over time, including shares≥one fifty, video views≥two thousand, ER≥8%, and trackable conversions.

The attribution server 110 further boosts posts that show a spike in the number of user interactions. In a few instances (e.g., a link from a story post on Instagram® or a link in bio—receive much less organic traffic, both of which are less likely to go ‘viral’), a post is boosted before any pixel-related impact is identified. An affiliate partner provides the organic traffic and data associated with the organic traffic using pixels. It uses unique identifiers to identify the source of the posts. Using unique identifiers, purchases related to the posts can be tracked. Urchin Tracking Modules (UTMs) tags from the purchase links are used to confirm the purchase. The post information related to post-performance and post-virality is retrieved from the business manager(s) 102 via the API or the social media platform(s) 106. The attribution server 110 boosts such posts and tracks the purchases from these posts. The attribution amount is calculated for the direct/indirect purchases from the boosted posts. The attribution amount is calculated for the boosted posts and allocated to the creator of the posts. The attribution amount is different for the boosted posts than for the pre-boost performance. The attribution amounts are displayed on the end-user device(s) 104.

The attribution amounts for the creators, details regarding the user interactions on the posts, and user data of social networking sites are stored in the data storage 114 for retrieval by the attribution server 110. The user interactions include clicks, likes, views, and purchases on the posts. The data storage 114 includes a past history of the posts, the user interactions on the posts, and the purchase history of the products/services from the posts.

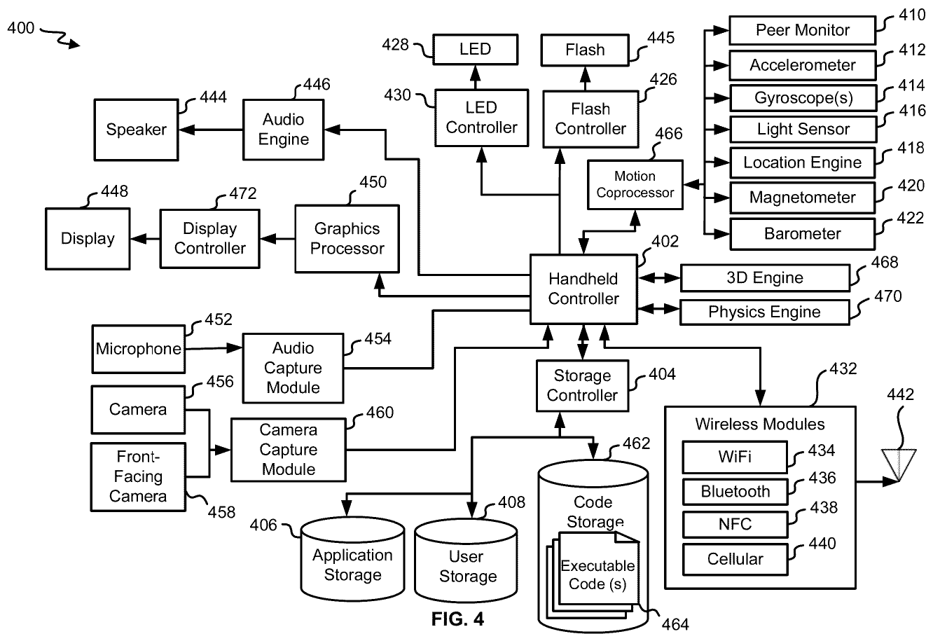

Referring to FIG. 4, illustrates a block diagram 200 of a user device and an application interface embedded with a system and/or apparatus for ticket booking according to an embodiment of the present disclosure. In one embodiment, the block diagram 200 includes an end-user device 202 and an application center 204, which are communicatively coupled with one another. In some embodiments, the end-user device 202 includes a client application 206 such that the client application 206 requests application data objects from the application center 204. Further, the application center 204 includes an application program interface (API) 208, a business logic 210, and data/schema objects 212 for performing various operations on data before transmitting data back to the client application.

In some embodiments, the client application 206 is downloaded from the application center 204 and then installed on the end-user device 202. The client application 206, upon execution on the end-user device 202, provides various features and options for creating and managing posts.

Referring to FIG. 3, a block diagram of the attribution server 110 is illustrated according to an embodiment of the present disclosure. The attribution server 110 manages an attribution amount for the creators or influencers of online social networking posts. The attribution server 110 includes a control engine 302, a post accumulator 304, a machine learning engine 306, a correlator 308, an attribution calculator 310, a source differentiator 312, a data cache 314, a tracker 316, a tester 318, and a power booster 320.

The control engine 302 manages the components of the attribution server 110 including the control engine 302, the post accumulator 304, the machine learning engine 306, the correlator 308, the attribution calculator 310, the source differentiator 312, the data cache 314, the tracker 316, the tester 318, and the power booster 320. The control engine 302 acquires user interactions (clicks, views) on the posts from the post accumulator 304, calculates the attribution amount for the posts based on the purchases from the user interactions using the attribution calculator 310, and provides the attribution amount of the creator of the post on the end-user device(s) 104 of the creator. The control engine 302 further calculates the attribution amount for the boosted post using the attribution calculator 310. It allocates the attribution amount to the creator of the post on the end-user device(s) 104 of the creator.

The post accumulator 304 acquires a set of posts from the social media platform(s) 106 based on the popularity of the post, content in the post, marketed products or services in the post, influencer's popularity, etc. The set of posts may be filtered by the business manager(s) 102 and provided to the post accumulator 304. The set of posts is provided by the post accumulator 304 to the control engine 302, and the set of posts is provided to the machine learning engine 306 by the control engine 302. User interactions (clicks, views, likes, purchases) on the post are provided to the control engine 302 by the business managers 102.

The machine learning engine 306 includes a number of machine learning algorithms that process the data related to the user interactions obtained from the business managers 102 via the control engine 302. The machine learning engine 306 processes purchases from clicks, views, third-party applications, company websites, mobile applications, direct purchases from the links in the posts, copied links from the posts, and purchases of marketed products and related products. The related products are associated with the post indirectly and are not mentioned directly in the post.

The correlator 308 performs a correlation of the purchases of the marketed products using the processing performed by the machine learning engine 306. The purchases from the clicks on the posts are correlated with the number of clicks on the posts. The purchases of the marketed products from the views on the posts are correlated with the number of views on the posts. The purchases of related products from the views and clicks on the posts are correlated with the number of views and clicks on the posts. The purchases of marketed and related products are made by users using third-party applications, mobile applications, direct purchases from the links in the posts, copied links from the posts, or company websites. Results of the correlation are provided to the attribution calculator 310. The correlation includes:
a number of views by users on the post-boosted candidate posts, with a number of views by users on the candidate posts;
the user interaction on the candidate posts, with the purchase from the clicks on the candidate posts;
the user interaction on the post-boosted candidate post, with the purchase from the clicks on the post-boosted candidate post;
the views by the users on the post-boosted candidate post, with the purchase from the views on the post-boosted candidate post;
the views by the users on the candidate posts, with the purchase based on the views on the candidate posts;
the purchase from the views on the post-boosted candidate posts, and the purchase from the views on the candidate posts; and
purchases from links on the candidate posts and the links on the post-boosted candidate posts with purchases from links on webpages, mobile applications, or third-party applications.

The attribution calculator 310 calculates commission for the creators or owners of the posts based on the direct sales of products or services generated from the posts and the indirect influence of the creators from the posts in driving the purchase decision of the users. The attribution amount is based on the result of the correlation performed by the correlator 308. The attribution amount is calculated as:
a view generating a sale of a relevant product on the client's/company's platform, but not the specific product being marketed within x days of viewing=the lowest percent commission/least valuable reward
a click generating a sale of a relevant product on the client's/company's platform, but not the specific product being marketed within x days of clicking=the second lowest percent commission/the second least valuable reward
a view generating a sale of the product being marketed within x days of viewing=the third lowest percent commission/third least valuable reward
a click generating a sale of the product being marketed within x days of clicking=the highest commission/most valuable reward

The attribution amount is calculated based on a set of predetermined rules. The predetermined rules include a percentage amount allocated to the owners based on the number of days of clicking, viewing, and purchasing marketed or related products and the type of source link. The source link is the direct links, hyperlinks, Uniform Resource Locators (URLs), copied links from the posts, payment link, mobile applications, third-party applications, websites, company websites, etc. The predetermined rules may be set by the control engine 302 using the machine learning engine 306 or may be preset by the company of the marketed product or service or the social media platform(s) 106.

The attribution amount for every single owner of the posts is stored in the data cache 314 for further retrieval by the control engine 302. The control engine 302 retrieves the attribution amount from the data cache 314. It allocates the attribution amount to the respective owners, which is displayed on the end-user device(s) 104 of the owners. The user data, including a number of users who purchased the marketed/related products/services from the posts, a number of clicks, and views on the posts, etc., are stored in the data cache 314 for further processing by the machine learning engine 306 or retrieval by the control engine 302.

The source differentiator 312 identifies and distinguishes the type of source link from the purchases of products/services. For example, the source differentiator identifies the direct links, copied links from the posts, hyperlinks, Uniform Resource Locators (URLs), payment links, mobile applications, third-party applications, websites, company websites, etc. The source differentiator 312 provides the type of source links to the attribution calculator 310 for calculating the attribution amount based on the type of source link.

The tracker 316 identifies pixel traffic from the posts. The pixel traffic is retrieved from the business manager(s) 102 using the API. The pixel traffic includes a number of user interactions on the posts, including clicks, views, and purchases. The spike is an increase in the number of user interactions on the posts. The tracker 316 further identifies a spike in the pixel traffic and triggers the tester 318 to test the spike.

The tester 318 identifies one or more posts responsible for the spike in the posts. The one or more posts may also be identified using the popularity of the creator or owner of the posts, the content of the posts, the products/services marketed through the posts, etc. The tester 318 further determined that one or more posts had to be boosted. The reach of one or more posts to a number of users has to be increased. Therefore, the number of views and clicks on one or more posts is increased.

The determination for the post that is to be boosted is made based on the boosting rules. The boosting rules are based on the Engagement Rate (ER), reach, video views, shares exceeding respective thresholds, and having trackable conversions over time. For example, according to a boosting rule that triggers a boost on posts only if every single condition is met over time, including ER≥3%, reach≥seven thousand, video views≥five thousand, shares≥fifty, and trackable conversions. Similarly, another boosting rule triggers a boost on posts if any of the conditions are met over time, including shares≥one fifty, video views≥two thousand, ER≥8%, and trackable conversions.

For example, in exceptional cases, a post getting four hundred views can be boosted to get more views. The amount by which one or more posts are boosted may be determined by the machine learning engine 306 or the company of the products/services. For example, the post getting the four hundred views can be boosted to one thousand views to analyse the post-boost impact. The amount of boosting (a number of increased views, clicks on the posts) is determined by the machine learning engine 306 based on processing the user data obtained from the business manager(s) 102. The identification of one or more posts and the amount of boosting is provided by the tester 318 to power booster 320 to amplify the reach of the posts to a larger set of users.

The power booster 320 uses a boosting signal based on the amount of boosting received from the tester 318 to amplify one or more posts. The indication of the boosted posts is provided to the control engine 302. User interactions from the boosted posts are received from the business manager(s) 102 via the API or the social media platform(s) 106 and further analysed by the machine learning engine 306. The correlator 308 compares direct (click-based) and indirect (view-based) purchases of the marketed/related products from the boosted posts. The purchases from the boosted posts are correlated to determine an attribution amount from the attribution calculator 310. The attribution amount from the boosted posts is provided to the control engine 302. The control engine 302 enables display of the attribution amount from the boosted posts on the end-user device(s) 104.

Referring to FIG. 4, a block diagram of an end-user device 400 is illustrated according to an embodiment of the present disclosure. The end-user device 400 includes a handheld controller 402 that can be sized and shaped so as to enable the controller and the end-user device 400 to be held in a hand. The handheld controller 402 can include one or more end-user device processors that can be configured to perform actions as described herein. In some instances, such actions can include retrieving and implementing a rule, retrieving an access-enabling code, generating a communication (e.g., including an access-enabling code) to be transmitted to another device (e.g., a nearby client-associated device, a remote device, a central server, a server, etc.), processing a received communication (e.g., to act in accordance with instruction in the communication, to generate a presentation based on data in the communication, or to generate a response communication that includes data requested in the received communication) and so on. In one embodiment, to guide the performance of different activities, the end-user device can use executable code tangibly stored in code storage 462, comprising executable code 464.

The handheld controller 402 can communicate with a storage controller 404 to facilitate local storage and/or retrieval of data. It would be appreciated if the handheld controller 402 could further facilitate storage and/or retrieval of data at a remote source via the generation of communications, including the data (e.g., with a storage instruction) and/or requesting particular data.

The storage controller 404 can be configured to write and/or read data from one or more data stores, such as an application storage 406 and/or a user storage 408. One or more data stores can include, for example, Random Access Memory (RAM), Dynamic Random Access Memory (DRAM), Read-Only Memory (ROM), flash-ROM, cache, storage chip, and/or removable memory. The application storage 406 can include various types of application data for a single application or multiple applications loaded (e.g., downloaded, or pre-installed) onto the end-user device. For example, one or more applications can include applications for scanning the ticket at the venue's entrance, the application running non-custodial wallets, and applications for other venue-related purchases. Further, application data can include, for example, application code, settings, profile data, databases, session data, history, cookies, and/or cache data. The user storage 408 can include, for example, files, documents, images, videos, voice recordings, and/or audio. It would be appreciated if the end-user device 400 could also include other types of storage and/or stored data, such as code, files, and data for an operating system configured for execution on end-user device 400.

The handheld controller 402 can also receive and process (e.g., in accordance with code or instructions generated in correspondence to a particular application) data from one or more sensors and/or detection engines. One or more sensors and/or detection engines can be configured to, for example, detect the presence, intensity, and/or the identity of (for example) another device (e.g., a nearby device or device-detectable over a particular type of networks, such as a Bluetooth, Bluetooth Low-Energy or Near-Field Communication network); an environmental, external stimulus (e.g., temperature, water, light, motion or humidity); an internal stimulus (e.g., temperature); a device performance (e.g., processor or memory usage); and/or a network connection (e.g., to indicate whether a particular type of connection is available, network strength and/or network reliability). The sensors and detection engines include a peer monitor 410, an accelerometer 412, a gyroscope 414, a light sensor 416, a location engine 418, a magnetometer 420, and a barometer 422. A singular sensor and/or detection engine can be configured to collect a measurement or decide, for example, at routine intervals or times and/or upon receiving a corresponding request (e.g., from a processor executing an application code).

The peer monitor 410 can monitor communications, networks, radio signals, short-range signals, etc., which can be received by a receiver of an end-user device 400. For example, the peer monitor 410 can detect short-range communication from another device and/or use a network multicast or broadcast to request identification of nearby devices. Upon or while detecting another device, the peer monitor 410 can determine an identifier, device type, associated user, network capabilities, operating system, and/or authorization associated with the device. The peer monitor 410 can maintain and update a data structure to store a location, identifier, and/or characteristic of several nearby end-user devices 400.

The accelerometer 412 can be configured to detect the proper acceleration of the end-user device 400. The acceleration can include multiple components associated with various axes and/or a total acceleration. The gyroscope 414 can be configured to detect one or more orientations (e.g., via detection of angular velocity) of end-user device 400. The gyroscope 414 can include, for example, one or more spinning wheels or discs, single- or multi-axis (e.g., three-axis) micro electro-mechanical systems (MEMS)-based gyroscopes.

The light sensor 416 can include, for example, a photosensor, such as a photodiode, active-pixel sensor, LED, photoresistor, or other component configured to detect the presence, intensity, and/or type of light. In some instances, one or more sensors and detection engines can include a motion detector, which can be configured to detect motion. Such motion detection can include processing data from one or more light sensors (e.g., performing a temporal and/or differential analysis).

The location engine 418 can be configured to detect (e.g., estimate) the location of end-user device 400. For example, the location engine 418 can be configured to process signals (e.g., a wireless signal, global positioning system (GPS) satellite signal, cell-tower signal, iBeacon, or base-station signal) received at one or more receivers (e.g., a wireless-signal receiver and/or GPS receiver) from a source (e.g., a GPS satellite, cellular tower, or base station, or Wi-Fi access point) at a defined or identifiable location. In some instances, the location engine 418 can process signals from multiple sources and can estimate the location of the end-user device 400 using a triangulation technique. In some instances, the location engine 418 can process a single signal and estimate its location to be the same as the location of the source of the signal.

The end-user device 400 can include a flash 445 and a flash controller 426. The flash 445 can include a light source, such as (for example) an LED, electronic flash, or high-speed flash. The flash controller 426 can be configured to control when the flash 445 emits light. In some instances, the determination includes identifying an ambient light level (e.g., via data received from the light sensor 416) and determining that the flash 445 is to emit light in response to a picture- or movie-initiating input when the light level is below a defined threshold (e.g. when a setting is in an auto-flash mode). In some additional or alternative instances, the determination includes determining that the flash controller 426 is, or is not, to emit light in accordance with a flash on/offsetting. When it is determined that the flash controller 426 is to emit light, the flash controller 426 can be configured to control the timing of the light to coincide, for example, with a time (or right before) at which a picture or video is taken.

The end-user device 400 can also include an LED 428 and an LED controller 430. The LED controller 430 can be configured to control when the LED 428 emits light. The light emission can be indicative of an event, such as whether a message has been received, a request has been processed, an initial access time has passed, etc.

The flash controller 426 can control whether the flash controller 426 emits light by controlling a circuit to complete a circuit between a power source and the flash controller 426 when the flash 445 is to emit light. In some instances, the flash controller 426 is wired to a shutter mechanism to synchronize light emission and the collection of image or video data.

The end-user device 400 can be configured to transmit and/or receive signals from other devices or systems (e.g., over one or more networks, such as network(s)). These signals can include wireless signals, and accordingly, the end-user device 400 can include one or more wireless modules 432 configured to appropriately facilitate the transmission or receipt of wireless signals of a particular type. The wireless modules 432 can include a Wi-Fi module 434, a Bluetooth module 436, a near-field communication (NFC) module shown as NFC 438, and/or a cellular module 440. Every single module can, for example, generate a signal (e.g., which can include transforming a signal generated by another component of the end-user device 400 to conform to a particular protocol and/or to process a signal (e.g., which can include transforming a signal received from another device to conform with a protocol used by another component of end-user device 400).

The Wi-Fi module 434 can be configured to generate and/or process radio signals with a frequency between 2.4 gigahertz and 5 gigahertz. The Wi-Fi module 434 can include a wireless network interface card that includes circuitry to facilitate communicating using a particular standard (e.g., physical and/or link-layer standard). The Bluetooth module 436 can be configured to generate and/or process radio signals with a frequency between 2.4 gigahertz and 2.485 gigahertz. In some instances, the Bluetooth module 436 can be configured to create and/or process Bluetooth low-energy (BLE or BTLE) signals with a frequency between 2.4 gigahertz and 2.485 gigahertz. The NFC 438 can be configured to generate and/or process radio signals with a frequency of 13.56 megahertz. The NFC 438 can include an inductor and/or can interact with one or more loop antennas. The cellular module 440 can be configured to generate and/or process cellular signals at ultra-high frequencies (e.g., between 698 and 2690 megahertz). For example, the cellular module 440 can be configured to generate uplink signals and/or to process received downlink signals.

The signals generated by the wireless modules 432 can be transmitted to one or more other devices (or broadcast) by one or more antennas 442. The signals processed by the wireless modules 432 can include those received by one or more antennas 442. The one or more antennas 442 can include, for example, a monopole antenna, helical antenna, Planar Inverted-F Antenna (PIFA), modified PIFA, and/or one or more loop antennas.

The end-user device 400 can include various input and output components. An output component can be configured to present output. For example, speaker 444 can be configured to present an audio output by converting an electrical signal into an audio signal. An audio engine 446 can affect particular audio characteristics, such as volume, event-to-audio-signal mapping, and/or whether an audio signal is to be avoided due to a silencing mode (e.g., a vibrate or do-not-disturb mode set at the device).

Further, a display 448 is provided with a display controller 472 and can be configured to present a visual output by converting an electrical signal into a light signal. The display 448 can include multiple pixels, where every single pixel, each of which can be individually controllable, such that the intensity and/or color of every single pixel can be independently controlled. The display 448 can include, for example, a light-emitting diode (LED) or liquid crystal display (LCD)-based display.

A graphics processor 450 can determine a mapping of electronic image data to pixel variables on a screen of the end-user device 400. It can further adjust lighting, texture, and color characteristics in accordance with, for example, user settings.

In some instances, the display 448 is a touchscreen display (e.g., a resistive or capacitive touchscreen) and is thus both an input and an output component. The graphics processor 450 can be configured to detect whether, where, and/or how (e.g., a force of) the user touched display 448. The determination can be made based on capacitive or resistive data analysis.

An input component can be configured to receive input from a user that can be translated into data. For example, end-user device 400 can include a microphone 452 that can capture audio data and transform the audio signals into electrical signals. An audio capture module 454 can determine, for example, when an audio signal is to be collected and/or any filter, equalization, noise gate, compression, and/or clipper that is to be applied to the signal.

The end-user device 400 can further include one or more cameras including camera 456, and a front facing camera 458, where every single camera 456 and 458 can be configured to capture visual data (e.g., at a given time or across an extended period) and convert the visual data into electrical data (e.g., electronic image or video data). In some instances, end-user device 400 includes multiple cameras, at least two of which are directed in different and/or substantially opposite directions. For example, end-user device 400 can include a rear-facing camera 456 and the front-facing camera 458.

A camera capture module 460 can control, for example, when a visual stimulus is to be collected (e.g., by controlling a shutter), a duration for which a visual stimulus is to be collected (e.g., a time that a shutter is to remain open for a picture taking, which can depend on a setting or ambient light levels; and/or a time that a shutter is to remain open for a video taking, which can depend on inputs), a zoom, a focus setting, and so on. When end-user device 400 includes multiple cameras, the camera capture module 460 can further determine which camera(s) are to collect image data (e.g., based on a setting). In some embodiments, components that assist with the processing and utilization of sensor data are included. Motion coprocessor 466, 3D engine 468, and physics engine 470 can process sensor data, and also perform tasks of graphics rendering related to the graphics processor 450.

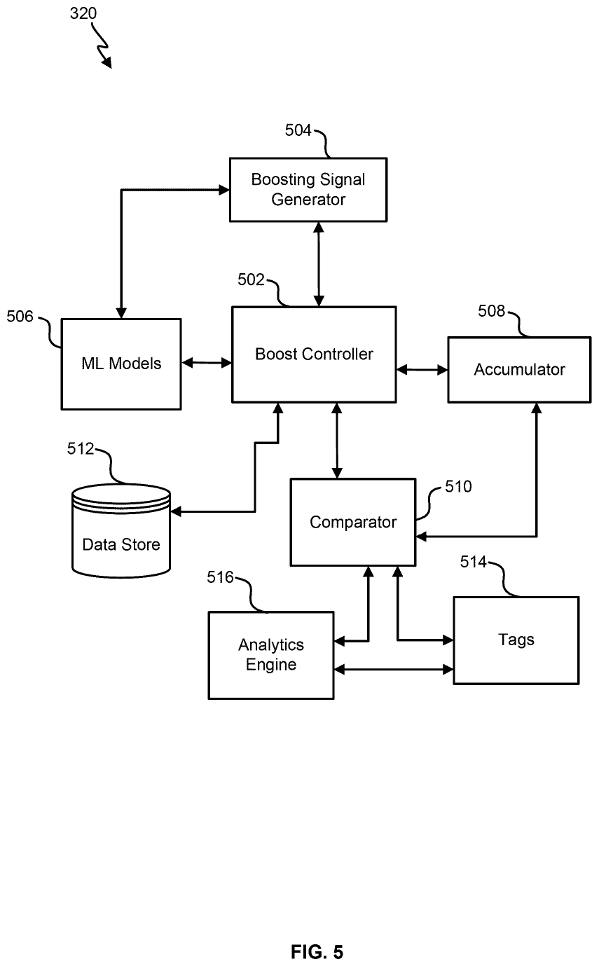

Referring to FIG. 5, a block diagram of the power booster 320 is illustrated according to an embodiment of the present disclosure. The power booster 320 receives posts from the tester 318 that have to be boosted and uses a boosting signal to boost the posts. The links from the boosted posts are converted to purchases of products or services and tracked by the business managers via the APIs. The tags are provided to the boosted posts to confirm the conversions. The posts are boosted to reach the audience interested in the content and inclined to purchase the products/services marketed in the posts. The power booster 320 includes a boost controller 502, a boosting signal generator 504, machine learning (ML) models 506, an accumulator 508, a comparator 510, a data store 512, tags 514, and an analytics engine 516.

The boost controller 502 receives the posts from the tester 318 that are boosted. The tester 318 determines the posts for boosting based on a number of boosting rules. The boosting rules are based on the Engagement Rate (ER), reach, video views, shares exceeding respective thresholds, and having trackable conversions over time. For example, according to a boosting rule that triggers a boost on posts only if every single condition is met over time, including ER≥3%, reach≥seven thousand, video views≥five thousand, shares≥fifty, and trackable conversions. Similarly, another boosting rule triggers a boost on posts if any of the conditions are met over time, including shares≥one fifty, video views≥two thousand, ER≥8%, and trackable conversions.

The boost controller 502 provides the posts to the ML models 506 and the boosting signal generator 504. The boosting signal generator 504 uses the ML models 506 to provide a boost in terms of the boosting signal to the boost controller 502. The amount of boost is an increase in the number of views or clicks, or user interactions that the posts are boosted to. For example, a post having four hundred views is boosted to one thousand views. The amount of boost is determined based on a number of factors, including the content of the posts, expected shares, likes, clicks, views, purchases, followers, and social profile of the owner of the posts.

The ML models 506 are used to determine the number of factors and provide the number of factors to the boosting signal generator 504 to determine the amount of boost. The boost also includes the targeted audience of the products/services mentioned in the posts and the users who are likely to purchase from the posts. The ML model 506 uses a training set from similar posts on the products/services to determine the targeted users. The user's purchase history, cart details, wish lists, likes, and booking information are used to identify the targeted users by the ML models 506. The amount of boost is transformed as the boosting signal and provided to the boost controller 502.

The accumulator 508 receives the boosted posts from the boost controller 502 and tracks the boosted posts. The details of the boosted posts are stored in the data store 512. The accumulator 508 checks the increase in the number of views and user interactions on the boosted posts. The user interactions include clicks, views, purchases, shares, etc. The accumulator 508 provides the user interactions to the comparator 510.

The comparator 510 receives the views on the boosted posts and compares the views with the views on the pre-boosted posts. The comparator 510 further identifies the user interactions on the boosted posts. The comparator 510 identifies purchases made using the links from the boosted posts. The purchase may be made instantly upon viewing the posts using the links from the boosted posts or using external links sometime later after viewing the posts. The comparator 510 provides the purchases from the boosted posts to the tags 514 and the analytics engine 516 for processing.

The tag 514 includes universal tags placed on the links used for the purchase of products/services. The universal tags determine the purchase and avoid any overreporting of the purchase of the products/services. The tags help classify the purchases made using different links. For example, purchases made using direct links from the posts, copied and pasted links in the browser, purchases using mobile applications of the products/services, or indirect external links or sources.

The analytics engine 516 identifies the purchase conversions from the boosted posts and identifies categories and links associated with the boosted posts. The purchases are used to calculate the attribution amount from the purchase. The analytics engine 516 uses the tag 514 and results from the comparator 510 to calculate the attribution amount for the different purchases of the products/services made using the boosted posts. For example, purchases made using the direct links have a different attribution amount, and purchases with indirect links have another attribution amount. The attribution amount is stored in the data store 512 and provided to users on the user interface of the end user device(s) 104.

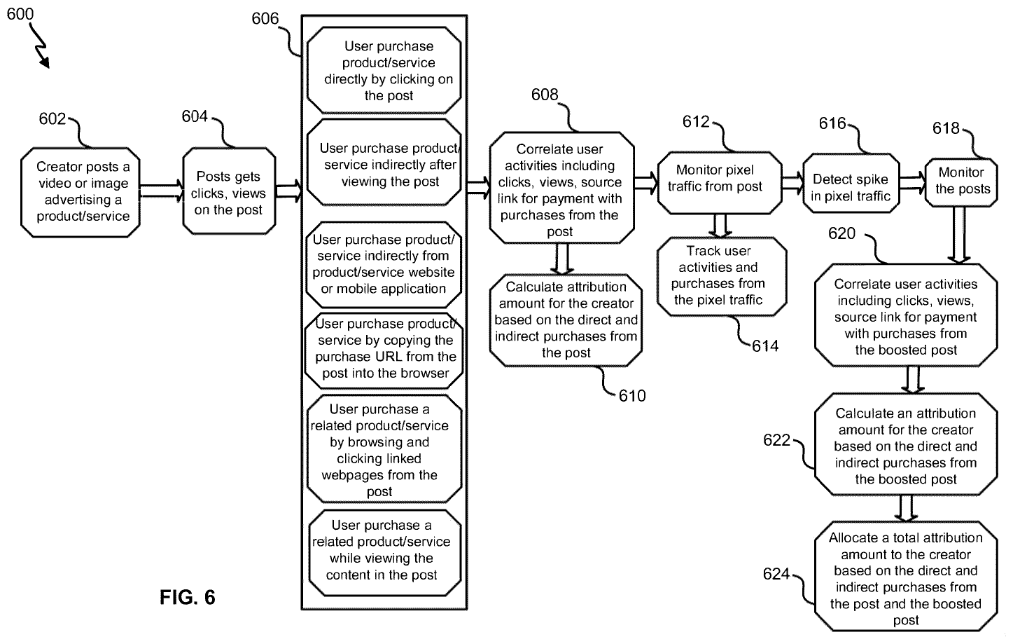

Referring to FIG. 6, a flow diagram 600 for the attribution management system 100 for determining an attribution amount for creators of an online post according to an embodiment of the present disclosure is illustrated. The attribution management system 100 determines an attribution amount based on the influence created by an owner of a post for purchasing a product or a service. Initially, at step 602, a creator or an influencer posts a video or image advertising a product or a service on the social media platform(s) 106 from a social media account. The creator is the owner of the post.

At step 604, the post is broadcast to a number of users who view or click on the post to purchase the product or the service. A user may directly purchase the product from a link in the post by clicking the link or indirectly purchase the product after a few days of viewing the post. The user may purchase the marketed products by clicking or viewing. The user may purchase a related product other than the marketed product from the link on the post or another link. The user may use the link in the post to purchase or copy and paste the link in the post on a browser to purchase from a third-party website, mobile application, or company website of the product or the service.

At step 606, user purchases from the post are determined. For example, user purchase of the product or the service directly by clicking on the post; user purchase of the product or the service indirectly after viewing the post; user purchase of the product or the service indirectly from the product or the service's company website or mobile application; user purchase of the product or the service by copying the purchase Uniform Resource Locator (URL) from the post into the browser; user purchase of a related product/service by browsing and clicking linked webpages from the post; and user purchase of a related product/service while viewing the content in the post.

At step 608, user activities correlate with post purchases, including clicks, views, and source links used for payment. For example, clicks by users are correlated with the purchases made by the clicks, and views by users are correlated with the purchases made by the views on the post. Similarly, source links, such as payment including coupon codes, payment links from posts, third-party websites, etc., are correlated with users and the owners of the posts.

At step 610, an attribution amount is calculated for the creator of the post based on the type of direct and indirect purchases from the post. The type of direct purchases includes purchases made using clicks, and the type of indirect purchases includes purchases made using views after some time or a few days later. Direct/indirect purchases also include purchases of marketed and related products/services made using clicks, views, and purchases made by copying links, direct payment links on posts, third-party websites, and mobile applications. The attribution amount is based on a type of direct and indirect purchase. A predetermined rule is set to allocate defined percentages of the attribution amount based on the type of purchase.

At step 612, the pixel traffic of the posts is monitored by the business manager(s) 102, as well as the data on user activities. The user activities, including clicks, likes, views, and purchases, are tracked at step 614 and provided to the attribution server 110 for analysis. The API is used to provide a direct link between the business manager(s) 102 and the attribution server 110. In another embodiment, the API directly links the social media platform(s) 106 and the attribution server 110.

At step 616, a spike or increase in the pixel traffic of posts is identified by the business manager(s) 102. The indication is provided to the attribution server 110 via the API or directly through the social media platform(s) 106.

At step 618, based on the indication of the spike in the pixel traffic, the attribution server 110 monitors the posts that indicate the spike. The increase in pixel traffic is an increase in user interactions and purchases on the posts. The attribution server 110 further performs analysis on the posts.

In an embodiment, the posts getting fewer views, clicks, and user interactions are boosted to increase the user interactions on the posts. The posts with the views, the clicks, or the user interactions below a predefined threshold value (for example, fifty views, ten clicks) are considered for boosting. The pixel traffic from the boosted posts is further analysed to identify the purchases associated with the boosted posts. The tags are used by the analytics engine 516 to determine the purchase conversions from views on the organic and boosted posts. The tags help to identify any overreporting of the purchase conversions. The tags are universal, such as Urchin Tracking Module (UTM), and the analytics engine 516 is a Google Analytics engine.

At step 620, the user activities, including clicks, views, and source links for payments of purchases on the boosted posts, are correlated with purchases from the boosted posts by the attribution server 110. At step 622, an attribution amount for the creator/owner of the boosted posts is calculated based on the direct (click based) and indirect (view based) purchases from the boosted post (mentioned at step 606).

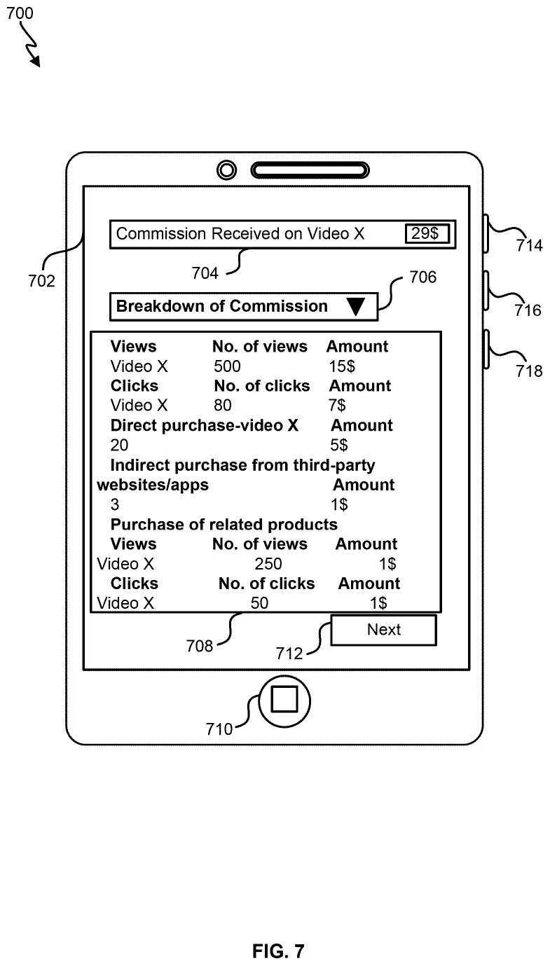

At step 624, a total attribution amount to the creator is allocated based on both the direct and indirect purchases from the boosted posts and provided to the creator of the post. A breakdown of the attribution amount from the direct and the indirect purchases is provided to the end-user device(s) 104 for display on the end-user device(s) 104 as shown in FIG. 7. A mobile application or a web application of the end-user device(s) 104 controlled by the attribution management system 100 displays the attribution amount from the boosted posts on the end-user device(s) 104.

Referring to FIG. 7, a mobile application running on the end-user device(s) 104 receives details of the attribution in terms of commission in accordance with an embodiment of the present disclosure. In one embodiment, FIG. 7 depicts a user device 700 that is used for managing the commission received by the creator of the post. The user device 700 includes a user interface 702 that displays multiple soft buttons and options for the user to view commissions received on a post by a user. A control button 710 is located at the bottom center of the user device 700, which enables the user to access different features of the device. A volume up switch 714 and a volume down switch 716 are used to adjust the volume of the device, and a lock screen button 718 is used to lock the device's screen.

The user interface 702 includes several elements, such as a commission icon 704, which shows the value of commission received for a particular post by the user. A breakdown commission icon 706 provides details of the commission received to the user. A commission detail section 708 includes commissions received from purchases made using clicks and views on the post, direct purchases of a marketed product from the post, and indirect purchases from other websites, links, and third-party websites from the post, and purchases from related products via clicks and views. A next button 712 is used to move to the next window for viewing commissions on the next post. Detailed analytics via graphs and charts may also be displayed on the user interface 702. The mobile application runs on the end-user device(s) 104 and communicates with the attribution server 110 to receive commission details on the user's posts. The commission is provided to the mobile application by the attribution server 110 for display on the user device 700.

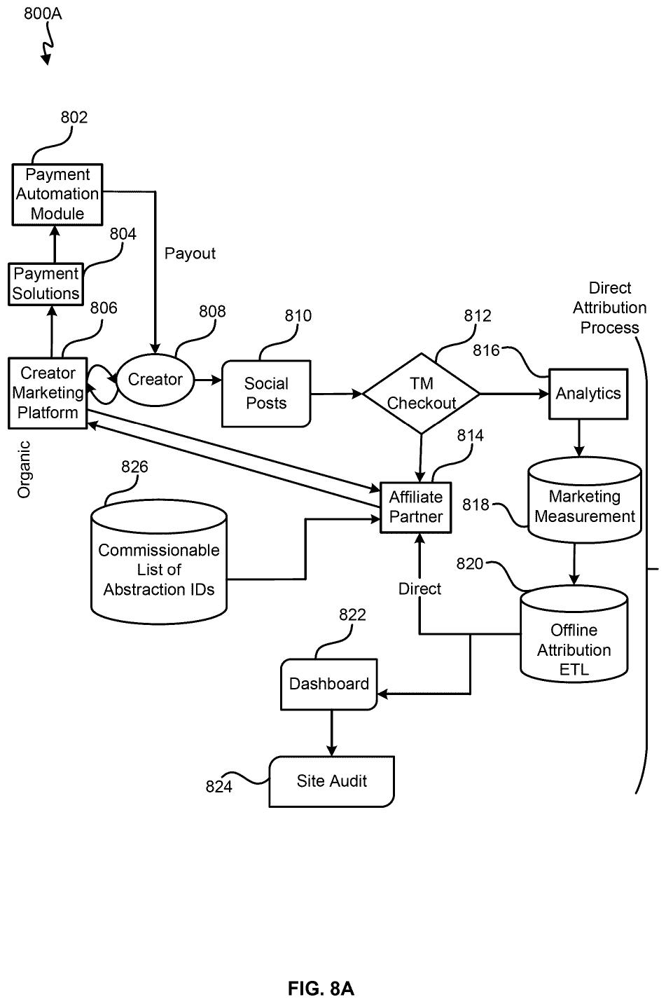

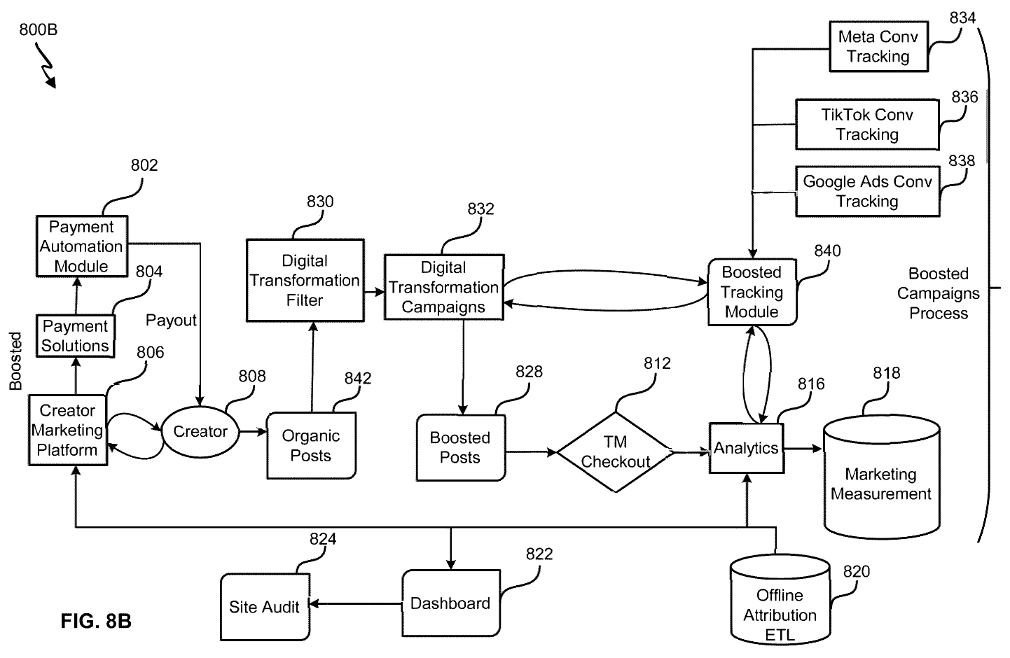

Referring to FIG. 8A, illustrates a flow diagram 800A describing attribution management of organic posts according to another embodiment of the present disclosure. The attribution management system 100 combines the unique data of creators obtained using the first-party data and the data from the social media platforms to pay an attribution amount for the views (indirect) on the posts and the clicks (direct). The attribution management system 100 further provides the attribution amount for the boosted posts to the creators of the posts. The flow diagram 800A includes a payment automation module 802, payment solutions 804, a creator marketing platform 806, a creator 808, social posts 810, time checkout 812, an affiliate partner 814, analytics 816, marketing measurement 818, offline attribution Extract, Transform, Load (ETL) 820, a dashboard 822, site audit 824, and a commissionable list of abstraction identifiers (IDs) 826.

The payment automation module 802, the payment solutions 804, and the creator marketing platform 806 are used to automate and manage payments to the creator of the post. For example, the payment automation module 802 may be a financial solution like Tipalti™. The payment solutions may be LexisNexis™ payment solutions for government companies. The creator marketing platform 806 may be Creator IQ™. The creator marketing platform 806 helps users/creators select a link that is customized according to the user/creator, and the link is used to assess the purchases made from the link.

The creator 808 uploads a post on a social media platform by uploading a video, an image, or a reel on an event, a product, or a service. The social posts 810 include posts that are uploaded on various social media platforms. The social media platforms track these posts. The posts have user interactions including likes, views, clicks, shares, comments, and purchases. The purchases are made via the time checkout 812. The purchase is of a ticket for an event, a product, or a service advertised in the post.

The purchases made from the post by clicking on a payment link on the post are direct purchases. The purchases made from the post by viewing the post and purchasing later, some time later, form an indirect purchase. The indirect purchase may be made using the link from the post by clicking on the link, copying and pasting the link in the browser, or using the mobile applications separately to purchase the tickets or the product/service.

The affiliate partner 814 provides the organic data related to the post to the creator marketing platform 806 to determine the links used for the purchase and segregate the purchase related to views (indirect purchase) and clicks (direct purchase). The organic data the affiliate partner 814 provided helps pay the creator 808 for the purchase (direct or indirect) made from the post.

The analytics 816 include pixels that provide details on providing an attribution amount for the views from the social media platform API using the social posts 810. The analytics 816 confirms the attribution amount from the purchase links (views) using tags like UTM tags.

The marketing measurement 818 stores statistics on the marketing of the event, product, or service included in the post. The marketing measurement 818 captures data, including product or service marketing purchases. The offline attribution ETL 820 captures the offline purchases and links used to make the offline purchase. The offline purchases are also attributed. The offline purchase may be in-store purchases, phone calls, or appointments linked to the online marketing via posts.

The dashboard 822 may be a Domo™ dashboard used for visualizations of the posts, links, purchases, user interaction, and attribution amount. The site audit 824 may be a Raven™ tool for site audits, rank tracking, and reporting. The dashboard 822 provides visibility to the users for the tracking posts and attribution management on the posts. The dashboard 822 and the site audit 824 provide a decision-making mechanism to determine the posts for boosting and the purchases from the views, clicks, etc., which are used to calculate the attribution amount for the purchase.

The commissionable list of abstraction identifiers (IDs) 826 includes a list of unique identifiers that are used to track the source of purchase, such as purchase links like source paid or source boosted. Direct and indirect purchases include purchases made using views. The attribution amount is calculated using the unique identifiers based on the source of the purchase.

Referring to FIG. 8B, illustrates a flow diagram 800B describing attribution management of boosted posts according to another embodiment of the present disclosure. The attribution management system 100 identifies posts for getting boosted. The boosted posts will have potentially higher views. The flowdiagram 800B includes the payment automation module 802, the payment solutions 804, the creator marketing platform 806, the creator 808, organic posts 842, the time checkout 812, the analytics 816, the marketing measurement 818, the offline attribution Extract, Transform, Load (ETL) 820, the dashboard 822, the site audit 824, boosted posts 828, a digital transformation filter 830, digital transformation campaigns 832, meta conversion tracking 834, TikTok conversion tracking 836, google ads conversion tracking 838, boosted tracking module 840, and organic posts 842.

The creator 808 posts a reel, video, or images as organic posts 842. The posts are used for marketing an event, a product, or a service. The organic posts 842 of the creator 808 are boosted based on the content of the post. The organic posts 842 are processed by the digital transformation filter 830 to determine the views, clicks, shares, forwards, purchases, and a boost signal for the organic posts 842.

The organic posts 842 is boosted using the digital transformation campaigns 832. The digital transformation campaigns 832 boost the organic posts using the boosting signal. The organic posts are boosted using modified advertising campaigns that increase the number of views and outreach to the anticipated audience through the boosted posts 828. The boosted posts 828 include the enhanced campaigns that are targeting the actual audience who are more likely to purchase the tickets, products, or services. These purchases are made via the time checkout 812. The purchases made from the boosted posts 828 include purchases by clicking on a payment link on the posts, which are direct purchases. The purchases made from the post are made by viewing the post and purchasing later, after some time, which forms an indirect purchase. The indirect purchase may be made using the link from the post by clicking on the link, copying and pasting the link in the browser, or using the mobile applications separately to purchase the tickets or the product/service.

The analytics 816 extracts the purchases from the boosted posts 828 and the boosted tracking module 840 to identify statistics from the purchases, for example, the users who purchased from the links in the boosted posts instantly (direct/clicks) or later (indirect/views). The attribution amount is calculated using the statistics.

The marketing measurement 818 stores the statistics on the purchases and marketing of the events, products, or services included in the boosted post. The marketing measurement 818 captures data including purchases from the marketing of the product or the service. The offline attribution ETL 820 captures the offline purchases and links used to make the offline purchase. The offline purchases are attributed accordingly. The offline purchase may be in-store purchases, phone calls, or appointments linked to the online marketing via the boosted posts.

The purchases from the boosted posts can be tracked using the social media APIs and the business managers. The Meta conversion tracking 834 extracts data associated with the boosted posts from Meta™, similarly, the TikTok™ conversion tracking 836 extracts data associated with the boosted posts on TikTok™, and the Google Ads™ conversion tracking 838 collates data associated with the boosted posts from Google Ads™.

The data includes purchase-related information from the boosted posts, user-related information, and analytics on the boosted posts. The data is provided to the boosted tracking module 840 from the meta conversion tracking 834, the TikTok conversion tracking 836, and the Google Ads™ conversion tracking 838. The boosted tracking module 840 stores and processes the data to identify the purchase information from the boosted posts. The purchase information is used to calculate the attribution amount by the analytics 816.

The dashboard 822 provides visualizations of the posts, links, purchases, user interaction, and attribution amount on a user interface for the users. The site audit 824 is used for website audits, rank tracking, and reporting. The dashboard 822 provides visibility to the users for the tracking posts and attribution management on the posts. The dashboard 822 and the site audit 824 provide insights into determining the attribution amount for purchases from the boosted posts. The dashboard 822, the site audit 824, and the offline attribution ETL 820 provide the website tracking, auditing, and attribution to the creator marketing platform 806 for payout of the attribution amount to the creator 808. The payout is provided to the creator 808 using the payment automation module 802 and the payment solutions 804.

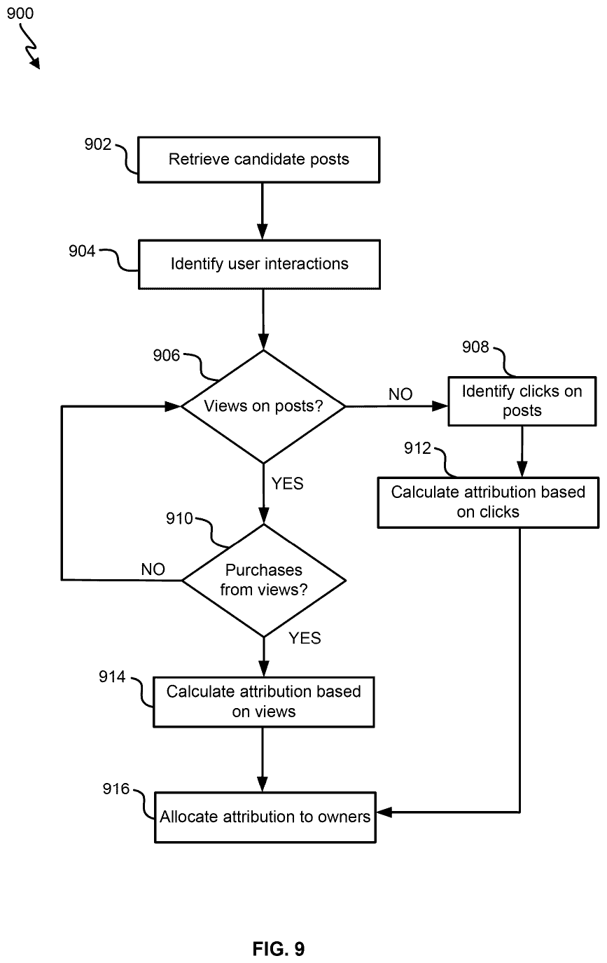

Referring to FIG. 9, illustrates a flowchart describing a process 900 for rewarding view-based attribution on an online platform such as social media according to another embodiment of the present disclosure. The process 902 begins when the attribution server 110 retrieves a number of candidate posts made by a number of creators, influencers, or owners of the candidate posts. The candidate posts include images, videos, text, advertisements (ads), animation, and/or a combination thereof, posted on social media sites. Based on a number of parameters, including popularity, number of followers, content, views, clicks, or likes on the posts, the attribution server 110 retrieves the candidate posts from the social media platform(s) 106.

At block 904, the attribution server 110 identifies user interactions on the candidate posts. The user interactions include clicks and views on the marketed products/services on the candidate posts, or clicks and views on related products/services on the candidate posts. The user interactions are analyzed to calculate an attribution amount for the owners of the candidate posts.

At block 906, the attribution server 110 continuously identifies a number of views on a candidate's posts. View-based attribution for the owner of the candidate post is calculated based on views. If the candidate post has received the views, then at block 910, purchases initiated from the views are identified at block 908, a number of clicks on the candidate post are identified, and purchases initiated using the clicks are identified. An attribution amount from the clicks of marketed/related products/services is calculated at block 912.

The purchases include purchases made on the marketed products/services using the views on the candidate posts after a few days, and purchases made on the related products/services using the views. The purchases also include purchases of the marketed products/services made by copying the Uniform Resource Locator (URL) of the marketed or related products/services provided in the candidate's post on their personal browser. The purchases also include purchases of the marketed or related products/services made using third-party websites, mobile applications of the products/services, or other links. The related products/services may or may not be provided in the candidate's post, but the user has browsed through several webpages or links to the products/services.

For example, a user may view content regarding product X on the candidate post. When the user purchases product X directly from the link in the candidate post a few days later, it is a view-based purchase. The user may use a coupon code from the owner for a discount while purchasing. The user may purchase the product X by copying the purchase link into the end-user device(s) browser 104. The user may purchase the product X directly from the product's website. The user may purchase another product Y found while browsing or viewing the product X. The purchase of products/services considers:
A view generating a sale of a relevant product on the clients platform but not the specific product being marketed within x days of viewing=the lowest percent commission/least valuable reward.
A click generating a sale of a relevant product on the clients platform but not the specific product being marketed within x days of clicking=the second lowest percent commission/second least valuable reward.
A view generating a sale of the product being marketed within x days of viewing=the third lowest percent commission/third least valuable reward.
A click generating a sale of the product being marketed within x days of clickgin=the highest commission/most valuable reward.

User information of the users viewing, clicking, or purchasing from the candidate post is obtained from the business manager(s) 102 using Application Programming Interfaces (APIs). The payment related data for providing the attribution amount to the owners is obtained from the payment server(s) 108 to the attribution server 110. The payment details of the users purchasing the products/services from the candidate posts are provided by the payment server(s) 108 to the attribution server 110.

At block 914, an attribution amount on the direct/indirect purchases of the marketed/related products/services based on the views is calculated, and at block 916, the attribution amount from the views is allocated to the owner of the candidate posts. The attribution amount from the clicks is also calculated separately and allocated to the owner. The attribution amount is based on a predetermined rule that sets predetermined percentage amounts for the type of purchase. The type of purchase includes purchases from clicks, views, direct/indirect links, webpages, applications, third-party applications, and marketed/related products/services. The attribution amount for the particular candidate posts and details of clicks, views, purchases, and other information associated with the candidate post is stored in the data storage 114 for analysis, processing, and retrieval.

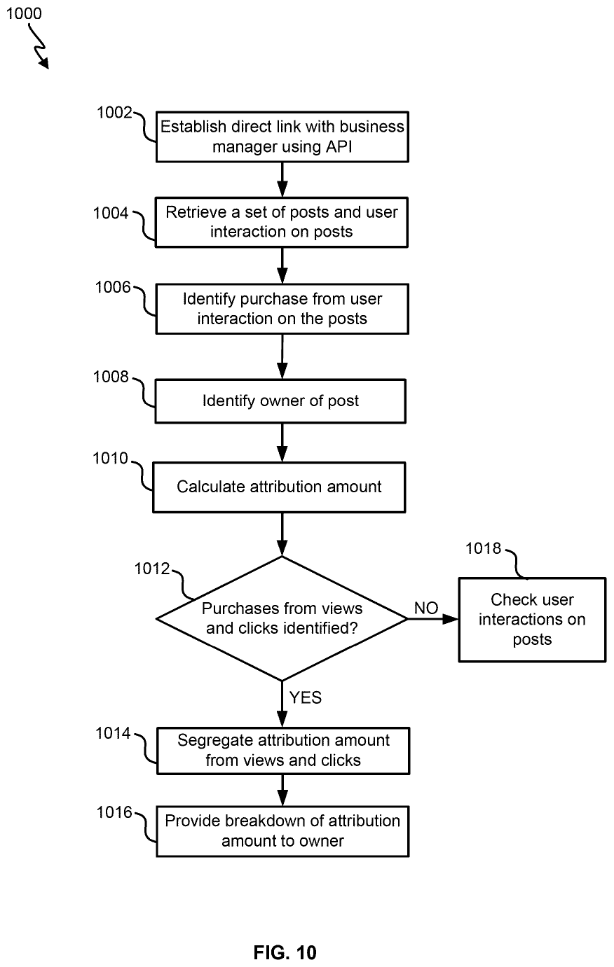

Referring to FIG. 10, illustrates a flowchart of a process 1000 for acquiring user data from business manager portals of social media platforms used for allocating attribution to users of social media candidate posts, according to another embodiment of the present disclosure. The process begins at block 1002, where a direct communication link is established between the attribution server 110 and the business manager(s) 102 using Application Programming Interfaces (APIs). In another embodiment, a direct link is established between the social media platform(s) 106 and the attribution server 110 using the APIs.

At block 1004, a set of candidate posts is retrieved by the attribution server 110 from the business manager(s) 102 using the APIs. The set of candidate posts includes images, videos, text, or a combination thereof, posted by the owner of the candidate posts. The set of candidate posts is selected from the candidate posts based on the content, popularity, advertising content, audience reach, etc. User interactions, including clicks and views, are collated for the set of candidate posts. The business manager(s) 102 receive the information regarding the user interactions. The set of candidate posts may advertise some products/services of a client or a company.

At block 1006, purchases initiated by users from one or more candidate posts are identified. The purchase information is retrieved from the business manager(s) 102 and confirmed by the payment server(s) 108. The purchase information includes user details of user purchases for the products/services marketed in the candidate posts. The users may perform the purchase by directly clicking on a link in the candidate posts or indirectly after viewing the candidate posts and purchasing using the link in the candidate posts after some time or a few days later. The purchase may be performed by copying the URL in the link on user's browser or directly purchasing the products/services from the company website or a third-party website. The purchase of related products/services is considered. The related products/services are identified while browsing different webpages, applications, or links.

At block 1008, the owners of one or more candidate posts are identified. Every single owner has contributed directly or indirectly to the marketing and sales of the advertised product/service through the candidate posts. Therefore, the owners are paid an attribution amount for their contribution.

At block 1010, an attribution amount is calculated for every single owner based on the purchase information received from the business manager(s) 102. The attribution amount is based on a type of purchase made using clicks or views, a marketed or related product/service, copied links, a direct link, a third-party website, or a mobile application. The attribution amount is based on a predetermined rule that sets predetermined percentage amounts for the type of purchase. The company of the products/services or the machine learning engine 306 sets the predetermined rule.

At block 1012, purchases from clicks and views are identified and differentiated. The information on the clicks and the views on the candidate posts is received from the business manager(s) 102. If the clicks and view based information is available then the attribution server 110 segregates the amount of attribution for the clicks and the views at block 1014. If the purchases from clicks or views is not made by any user, then at block 1018, the attribution server 110 keeps tracking the user interactions from the business manager(s) 102 to identify clicks, views, and purchases from the clicks and views.

At block 1016, a breakdown of the attribution amount contributed from the clicks and views is provided to each owner of the respective candidate post, as shown in FIG. 7. The attribution amount from the clicks and views is displayed on a mobile application of the end-user device(s) 104.

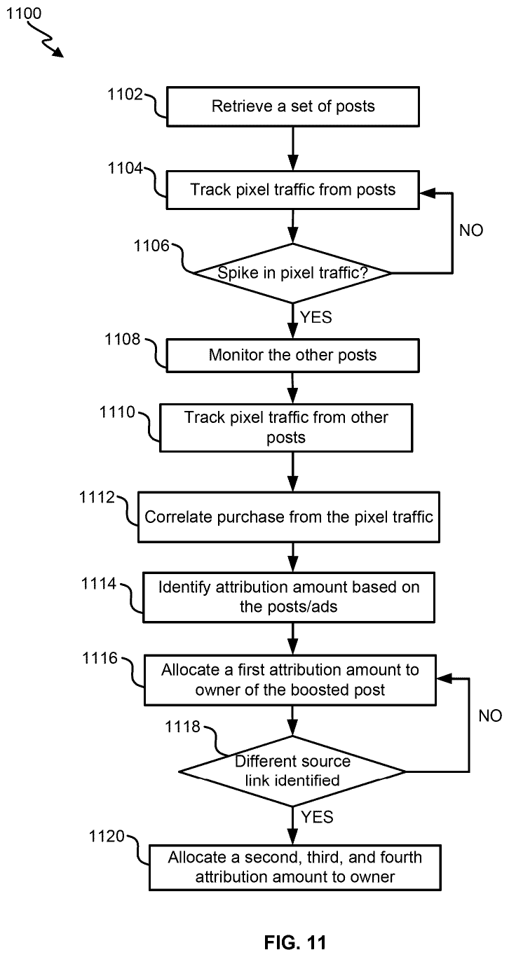

Referring to FIG. 11, illustrates a flowchart of a process 1100 for boosting pixel traffic associated with a set of candidate posts and generating a commission for purchases initiated after boosting the pixel traffic according to another embodiment of the present disclosure. The process begins at block 1102, when a set of candidate posts is retrieved by the attribution server 110 from the business manager(s) 102 via an Application Programming Interface (API). The set of candidate posts may be images, text, and/or video candidates posted by owners of the set of candidate posts from their social media account. The set of candidate posts may include marketed products/services. The set of candidate posts may be randomly retrieved or selected based on popularity, content, advertisements, products, or influencers, etc.

At block 1104, pixel traffic associated with the set of candidate posts is monitored by the attribution server 110 based on information from the business manager(s) 102. The set of candidate posts initially has a number of user interactions in the form of clicks, views, and purchases. The pixel traffic includes the number of user interactions on the set of candidate posts. The pixel traffic from the set of candidate posts that includes details on the user interactions, for example, number of clicks, views, is retrieved from the business manager(s) 102 by the attribution server 110.

At block 1106, a spike in the pixel traffic is detected by the attribution server 110. The spike includes an increase in the number of user interactions on the set of candidate posts. If the spike is detected, then the process moves to block 908; else, the pixel traffic is tracked continuously at block 1104. At block 1108, other candidate posts are also monitored to identify the number of user interactions on the candidate posts other than the candidate posts that have shown a spike in the number of user interactions.

At block 1110, the pixel traffic from other posts is tracked. In case of a set of candidate posts that shows the least user interactions of the candidate posts monitored, the set of candidate posts is boosted. A boosting signal is generated to boost the number of user interactions on the candidate posts and increase the reach of the candidate posts to a larger audience (users). One or more candidate posts are selected from the set of candidate posts to boost the user interactions (clicks, views, likes, purchases, convoyed purchases) based on the number of clicks and views on the candidate posts being less than a pre-defined threshold value. The boosting signal is selected based on a predetermined amount set by the attribution server 110. The boosting signal is based on a number of clicks and views by which the current user's interactions are to be increased. For example, if a candidate's post has 100 views and 50 clicks, and there are 500 tickets available for sale. The attribution server 110 may boost the candidate post such that the views increase to approximately 1500, and the number of clicks increases to approximately 1000. The machine learning engine 306 may set and modify this predetermined amount based on the current traffic on the candidate post.

At block 1112, purchases made by a set of users using one or more boosted candidate posts with the user interactions are correlated. The correlation may be performed by a machine learning algorithm of the attribution server 110.

At block 1114, a first attribution amount is calculated based on the correlation between the user interactions on one or more boosted candidate posts and the post-boost traffic purchases from one or more boosted candidate posts. An attribution amount for the set of candidate posts is calculated separately.

At block 1116, the first attribution amount is allocated to each owner of one or more candidate posts for the contribution to the sales based on the boosted candidate posts. The owners of one or more candidate posts are provided with the first attribution amount on the respective end-user device(s) 104.

At block 1118, a source link associated with the purchases from one or more candidate posts is identified. The source link includes direct links from the social media candidate post, mobile applications, copied links, browser links, payment link, a webpage, a code, or third-party source links. The source link is identified to track the source of the purchases. A source link other than the source link used in the candidate post is identified and, accordingly, at block 1120, a second attribution amount based on the source links is calculated and allocated to the owners of one or more candidate posts on the end-user device(s) 104. Else, if a source link different from the direct link on the candidate post is not identified, then only the first attribution amount is allocated to the owners at block 1116.

A third attribution amount for every single owner of the one or more candidate posts is calculated and allocated to the respective owners based on the views on the one or more candidate posts and a fourth attribution amount for every single owner of the one or more candidate posts is calculated and allocated to the respective owners based on the clicks on the one or more candidate posts.

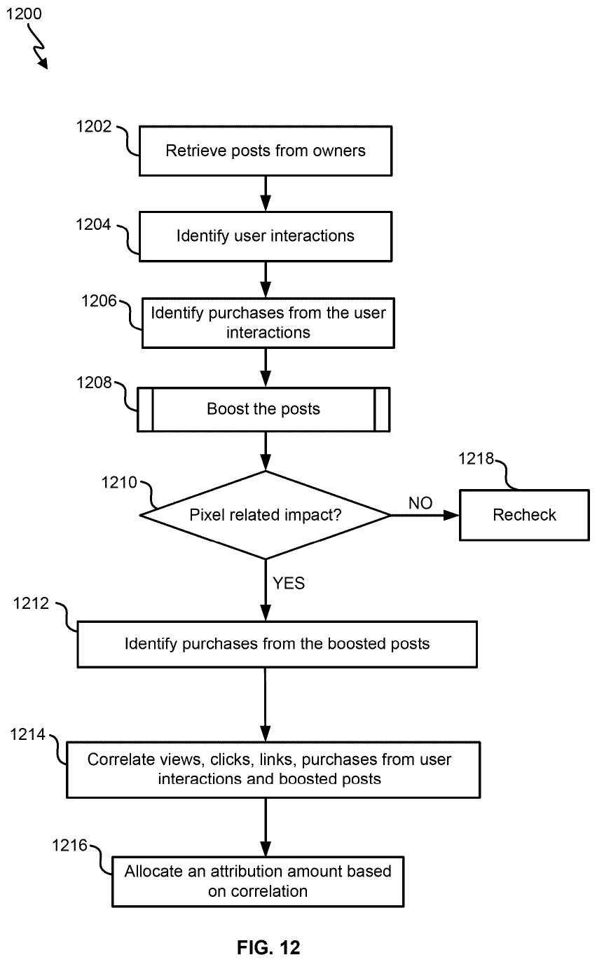

Referring to FIG. 12, illustrates a flowchart of a process 1200 for correlating user interactions on a number of candidate posts with sales/revenue generated from the candidate posts according to another embodiment of the present disclosure. The process begins at block 1202, where candidate posts from a plurality of candidate posts are retrieved by the attribution server 110 from the business manager(s) 102 using an Application Programming Interface (API). The candidate posts are posted by influencers, creators from their social media accounts on the social media platform(s) 106. The candidate posts may include marketed products/services. The candidate posts are selected based on the user interactions, including clicks and views on the candidate posts, popularity of the content of the candidate post, or the influencer or advertising content in it.

At block 1204, user interactions are identified by the attribution server 110 on the candidate posts. The clicks, views, and purchases on the candidate posts are tracked by the business manager(s) 102 on the candidate posts. The user interactions provide data on the popularity and reach of the candidate posts to the users.

At block 1206, purchases from the candidate posts are identified, the purchases are segregated from clicks, and views are used to differentiate the purchases made using the clicks and the views on the candidate posts.

At block 1208, based on a number of clicks and views by users on the candidate posts below a threshold value, a set of candidate posts is boosted to further increase the reach of the candidate posts to an increased number of users. The candidate posts having the least user interactions compared to other candidate posts among the plurality of candidate posts are considered for boosting. Boosting increases the number of user interactions on the candidate posts.

At block 1210, the pixel impact of the boosted candidate boosts is analyzed. The pixel traffic from the boosted candidate posts is analyzed for tracking performance (a number of user interactions) of the candidate posts after boosting. If there is an increase in the number of user interactions on the candidate posts after boosting, then the process moves to block 1012 else the performance is tracked continuously at block 1018.

At block 1212, purchases made from the boosted candidate posts are identified by the attribution server 110. The purchases are expected to increase after boosting the candidate posts.

At block 1214, the attribution server 110 correlates purchases from the candidate posts and the purchases from the boosted candidate posts. Views, clicks, payment links, purchases from user interactions and boosted posts are correlated with one another to analyze the influence the owner of the candidate post has on the users in terms of the direct/indirect purchases from the candidate posts. These correlations can be performed using a machine learning algorithm of the attribution server 110. The correlations include:
the clicks on the post-boosted candidate post with the purchase from the clicks on the post-boosted candidate post;
the views by the users on the post-boosted candidate post, with the purchase from the views on the post-boosted candidate post;
purchases from links on the post-boosted candidate posts with purchases from links on webpages, mobile applications, or third-party applications.

At block 1216, an attribution amount is allocated to the owners of the candidate posts and the post-boosted candidate posts based on the correlation.

The owners of the candidate posts and the post-boosted candidate posts are allocated the attribution amount separately. The attribution amount is received in the owners' bank account or wallet and displayed on their end-user device(s) 104.

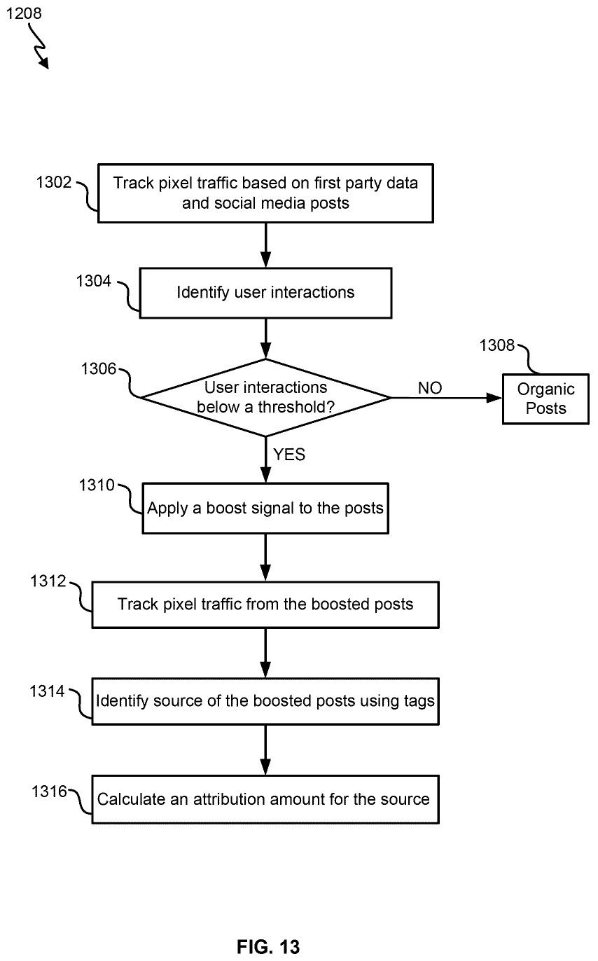

Referring to FIG. 13, illustrates a flowchart of the block 1208 for determining and boosting a set of candidate posts according to another embodiment of the present disclosure. The process begins at block 1302, where pixel traffic from the candidate posts is tracked based on first-party data and social media posts. The candidate posts are retrieved from a business manager using the API. The social media posts are acquired from the business managers of the social media using the APIs.

At block 1304, user interactions are identified from the pixel traffic. The pixel traffic includes a number of user interactions. The user interactions include clicks and views on the candidate posts, and the first-party data includes user data from user applications (mobile, cloud, or web-based applications) associated with the candidate posts. The candidate posts are identified from the set of candidate posts based on Engagement Rate (ER), reach, video views, shares exceeding respective thresholds, and having a set of trackable conversions over time.

At block 1306, it is determined whether the number of user interactions is below a pre-defined threshold value. The user interactions include clicks and views. If the number of user interactions is above the pre-defined threshold value, the candidate posts are not boosted and are considered as the organic posts at block 1308. The attribution amount is calculated for the purchase of tickets, products, or services from the organic posts and allocated to the creator or owner of the candidate posts.

When the number of clicks and views is below the pre-defined threshold value, it is determined that the candidate posts are to be boosted. The content of the candidate posts, the targeted users for purchase, and the purchase history of users are some parameters used to determine the candidate posts for boosting, along with the number of user interactions. The power booster 320 determines a predetermined number of user interactions used to boost the candidate posts. For example, four hundred views can be boosted by a predetermined amount of six hundred views to reach one thousand views.

At block 1310, a boosting signal proportional to the predetermined number of user interactions is applied to the candidate posts by the power booster 320. The boosting signal increases the number of clicks and views on the candidate posts, thereby increasing the targeted users and purchases from the candidate posts.

At block 1312, pixel traffic is tracked from the boosted candidate posts. The pixel traffic is tracked using the analytics engine 516 to identify the source of the boosted candidate posts. The source includes a link to the purchase. The source may be related to the direct or indirect purchase link.

At block 1314, the analytics engine 516 uses tags to identify the source of the boosted candidate posts. The source is associated with the user account of the user who made the purchase. The analytics engine 516 may be Google Analytics™, and the tags are UTM tags placed on the source links to identify the purchase.

The purchases made by the users who are initiated using the boosted candidate posts are identified. The owners of the boosted candidate posts associated with the purchases are identified based on the source of the boosted candidate posts.

At 1316, an attribution amount is calculated for each owner of the boosted candidate posts. The attribution amount is calculated based on the purchase made using the source link identified by the tags. The attribution amount is allocated to the owner of the boosted candidate posts.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, non-volatile, or other storage medium and is not to be limited to any particular type of memory or number of memories, or type of media upon which memory is stored.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data. These machine-readable instructions may be stored on one or more machine-readable mediums, such as CD-ROMs or other type of optical disks, solid-state drives, tape cartridges, ROMs, RAMs, EPROMS, EEPROMs, magnetic or optical cards, flash memory, or other types of machine-readable mediums suitable for storing electronic instructions. Alternatively, the methods may be performed by a combination of hardware and software.

Implementation of the techniques, blocks, steps, and means described above may be done in various ways. For example, these techniques, blocks, steps, and means may be implemented in hardware, software, or a combination thereof. For a digital hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. For analog circuits, they can be implemented with discreet components or using monolithic microwave integrated circuit (MMIC), radio frequency integrated circuit (RFIC), and/or micro electro-mechanical systems (MEMS) technologies.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

While the principles of the disclosure have been described above in connection with specific apparatuses and methods, it is to be clearly understood that this description is made only by way of example and not as limitation on the scope of the disclosure.

We claim:

1. A method for boosting pixel traffic of candidate posts and generating a commission for purchases initiated on boosting the pixel traffic, the method comprising:
retrieving, by an attribution server, from a business manager using an Application Programming Interface (API) over a data communication network, a set of candidate posts;
tracking using the business manager, pixel traffic from the set of candidate posts based on first-party data and social media posts, wherein the pixel traffic includes a number of user interactions, the user interactions include clicks, and views on the set of candidate posts, and the first-party data includes user data from user applications associated with the set of candidate posts;
identifying a one or more candidate posts from the set of candidate posts that have the number of user interactions below a pre-defined threshold value;
applying a boost signal to the one or more candidate posts based on a predetermined number of user interactions to generate a one or more boosted candidate posts;
tracking the pixel traffic from the one or more boosted candidate posts, wherein the pixel traffic is tracked using an analytics engine to identify a source of the one or more boosted candidate posts, and the analytics engine uses tags to identify the source of the one or more boosted candidate posts;
identifying at least one purchase by a set of users initiated using the one or more boosted candidate posts;
identifying, by the attribution server, owners of the one or more boosted candidate posts associated with at least one purchase based on the source of the one or more boosted candidate posts; and
calculating, by the attribution server, an attribution amount for each owner of the one or more boosted candidate posts based on the at least one purchase using the source identified by using the tags.

2. The method of claim 1, further comprising:
acquiring user-related data from the pixel traffic using the API based on a user device identifier and user account information associated with users identified from the source of the pixel traffic;
identifying at least one purchase by a plurality of users initiated using the set of candidate posts;
allocating, by the attribution server, the attribution amount to each owner of the set of candidate posts for the at least one purchase initiated from the set of candidate posts;
correlating the at least one purchase by the set of users initiated using the one or more boosted candidate posts with the user interactions on the one or more boosted candidate posts; and
allocating, by the attribution server, the attribution amount to each owner of the one or more boosted candidate posts for the at least one purchase initiated from the one or more boosted candidate posts.

3. The method of claim 1, further comprising:
differentiating, by the attribution server, source links of the at least one purchase by the set of users initiated using the one or more boosted candidate posts based on the user data;
calculating, by the attribution server, a first attribution amount for each owner of the one or more boosted candidate posts based on the source links;
calculating, by the attribution server, a second attribution amount for each owner of the one or more boosted candidate posts based on the views on the one or more boosted candidate posts; and
calculating, by the attribution server, a third attribution amount for each owner of the one or more boosted candidate posts based on the clicks on the one or more boosted candidate posts.

4. The method of claim 3, wherein the first attribution amount is a function of a type of source link, and the type of source link is a payment link, a webpage, or a code used for the at least one purchase.

5. The method of claim 2, wherein the correlation of the at least one purchase by the set of users initiated using the one or more boosted candidate posts with the at least one purchase by the plurality of users initiated using the set of candidate posts is performed using a machine learning algorithm.

6. The method of claim 1, wherein the one or more candidate posts are identified from the set of candidate posts based on Engagement Rate (ER), reach, video views, shares exceeding respective thresholds and having trackable conversions over time.

7. The method of claim 1, wherein the one or more candidate posts are identified from the set of candidate posts based on any one of shares, video views, Engagement Rate (ER) exceeding respective thresholds and having trackable conversions over time.

8. An attribution management system for boosting pixel traffic of candidate posts and generating a commission for purchases initiated on boosting the pixel traffic, comprising:
an attribution server configured to:
retrieve, from a business manager using an Application Programming Interface (API) over a data communication network, a set of candidate posts;
track using the business manager, pixel traffic from the set of candidate posts based on first-party data and social media posts, wherein the pixel traffic includes a number of user interactions, the user interactions include clicks, and views on the set of candidate posts, and the first-party data includes user data from user applications associated with the set of candidate posts;
identify a one or more candidate posts from the set of candidate posts that have the number of user interactions below a pre-defined threshold value;
apply a boost signal to the one or more candidate posts based on a predetermined number of user interactions to generate a one or more boosted candidate posts;
track the pixel traffic from the one or more boosted candidate posts, wherein the pixel traffic is tracked using an analytics engine to identify a source of the one or more boosted candidate posts, and the analytics engine uses tags to identify the source of the one or more boosted candidate posts;
identify at least one purchase by a set of users initiated using the one or more boosted candidate posts;
identify owners of the one or more boosted candidate posts associated with the at least one purchase based on the source of the one or more boosted candidate posts; and
calculate an attribution amount for each owner of the one or more boosted candidate posts based on the at least one purchase using the source identified by using the tags.

9. The attribution management system of claim 8, wherein the attribution server is further configured to:
acquire user-related data from the pixel traffic using the API based on a user device identifier and user account information associated with users identified from the source of the pixel traffic;
identify at least one purchase by a plurality of users initiated using the set of candidate posts;
allocate by the attribution server the attribution amount to each owner of the set of candidate posts for the at least one purchase initiated from the set of candidate posts;
correlate the at least one purchase by the set of users initiated using the one or more boosted candidate posts with the user interactions on the one or more boosted candidate posts; and
allocate by the attribution server the attribution amount to each owner of the one or more boosted candidate posts for the at least one purchase initiated from the one or more boosted candidate posts.

10. The attribution management system of claim 8, further comprises:
differentiate, by the attribution server, source links of the at least one purchase by the set of users initiated using the one or more boosted candidate posts based on the user data;
calculate, by the attribution server, a first attribution amount for each owner of the one or more boosted candidate posts based on the source links;
calculate, by the attribution server, a second attribution amount for each owner of the one or more boosted candidate posts based on the views on the one or more boosted candidate posts; and
calculate, by the attribution server, a third attribution amount for each owner of the one or more boosted candidate posts based on the clicks on the one or more boosted candidate posts.

11. The attribution management system of claim 10, wherein the first attribution amount is a function of a type of source link, and the type of source link is a payment link, a webpage, or a code used for the at least one purchase.

12. The attribution management system of claim 9, wherein the attribution server is further configured to correlate, using a machine learning algorithm, the at least one purchase by the set of users initiated using the one or more boosted candidate posts with the at least one purchase by the plurality of users initiated using the set of candidate posts.

13. The attribution management system of claim 8, wherein the attribution server is further configured to identify the one or more candidate posts from the set of candidate posts based on Engagement Rate (ER), reach, video views, shares exceeding respective thresholds and having trackable conversions over time.

14. The attribution management system of claim 8, wherein the one or more candidate posts are identified from the set of candidate posts based on any one of shares, video views, Engagement Rate (ER) exceeding respective thresholds and having and trackable conversions over time.

15. A non-transitory computer-readable medium containing instructions that, when executed by a processor, cause the processor to perform a method for boosting pixel traffic of candidate posts and generating a commission for purchases initiated on boosting the pixel traffic, the method comprising:
retrieving, by an attribution server, from a business manager using an Application Programming Interface (API) over a data communication network, a set of candidate posts;
tracking using the business manager, pixel traffic from the set of candidate posts based on first-party data and social media posts, wherein the pixel traffic includes a number of user interactions, the user interactions include clicks, and views on the set of candidate posts, and the first-party data includes user data from user applications associated with the set of candidate posts;
identifying a one or more candidate posts from the set of candidate posts that have the number of user interactions below a pre-defined threshold value;
applying a boost signal to the one or more candidate posts based on a predetermined number of user interactions to generate a one or more boosted candidate posts;
tracking the pixel traffic from the one or more boosted candidate posts; wherein the pixel traffic is tracked using an analytics engine to identify a source of the one or more boosted candidate posts, and the analytics engine uses tags to identify the source of the one or more boosted candidate posts;
identifying at least one purchase by a set of users initiated using the one or more boosted candidate posts;
identifying, by the attribution server, owners of the one or more boosted candidate posts associated with the at least one purchase based on the source of the one or more boosted candidate posts; and
calculating, by the attribution server, an attribution amount for each owner of the one or more boosted candidate posts based on the at least one purchase using the source identified by using the tags.

16. The non-transitory computer-readable medium of claim 15, wherein the method further comprises:
acquiring user-related data from the pixel traffic using the API based on a user device identifier and user account information associated with users identified from the source of the pixel traffic;
identifying at least one purchase by a plurality of users initiated using the set of candidate posts;
allocating, by the attribution server, the attribution amount to each owner of the set of candidate posts for the at least one purchase initiated from the set of candidate posts;
correlating the at least one purchase by the set of users initiated using the one or more boosted candidate posts with the user interactions on the one or more boosted candidate posts; and
allocating, by the attribution server, the attribution amount to each owner of the one or more boosted candidate posts for the at least one purchase initiated from the one or more boosted candidate posts.

17. The non-transitory computer-readable medium of claim 15, wherein the method further comprises:
differentiating, by the attribution server, source links of the at least one purchase by the set of users initiated using the one or more boosted candidate posts based on the user data;
calculating, by the attribution server, a first attribution amount for each owner of the one or more boosted candidate posts based on the source links;
calculating, by the attribution server, a second attribution amount for each owner of the one or more boosted candidate posts based on the views on the one or more boosted candidate posts; and
calculating, by the attribution server, a third attribution amount for each owner of the one or more boosted candidate posts based on the clicks on the one or more boosted candidate posts.

18. The non-transitory computer-readable medium of claim 17, wherein the first attribution amount is a function of a type of source link, and the type of source link is a payment link, a webpage, or a code used for the at least one purchase.

19. The non-transitory computer-readable medium of claim 16, wherein the correlation of the at least one purchase by the set of users initiated using the one or more boosted candidate posts with the at least one purchase by the plurality of users initiated using the set of candidate posts is performed using a machine learning algorithm.

20. The non-transitory computer-readable medium of claim 15, wherein the one or more candidate posts are identified from the set of candidate posts based on Engagement Rate (ER), reach, video views, shares exceeding respective thresholds and having trackable conversions over time.
